(19) United States
(12) Patent Application Publication
(10) Pub. No.: US 2019/0089023 A1
(43) Pub. Date: Mar. 21, 2019

(54) ENERGY STORAGE SYSTEM

(71) Applicant: Dyson Technology Limited, Wiltshire (GB)

(72) Inventors: Ann Marie SASTRY, Ann Arbor, MI (US); Chia-Wei WANG, Ypsilanti, MI (US); Yen-Hung CHEN, Ann Arbor, MI (US); Xiangchun ZHANG, Ann Arbor, MI (US); HyonCheol KIM, Ann Arbor, MI (US); Myoungdo CHUNG, Ann Arbor, MI (US)

(73) Assignee: Dyson Technology Limited, Wiltshire (GB)

(21) Appl. No.: 15/705,440

(22) Filed: Sep. 15, 2017

(51) Int. Cl. H01M 10/48; H01M 10/46; H01M 10/42

(52) U.S. Cl. CPC H01M 10/486; H01M 10/4207; H01M 10/46

(57) ABSTRACT

An integrated energy storage system can include a first, second, and third energy storage units and a controller. The first energy storage units can have a gravimetric energy density of greater than 180 Wh/kg and volumetric energy density greater than 450 Wh/L in an environmental temperature above 0° C., the second energy storage units can have a gravimetric power density of greater than 450 W/kg and volumetric power density greater than 1080 W/L in an environmental temperature above 0° C., and the third energy storage units can be configured to operate in an environmental temperature as low as −100° C. The controller can be programmed to receive inputs from voltage sensors, current sensors, and temperature sensors, and to allocate the current or power among the first, second, or third energy storage units depending on a power consumption from an application load and an environmental temperature.

### FIELD OF THE INVENTION

The present invention relates to techniques for manufacturing energy storage devices. More specifically, the present invention provides integrated energy storage systems that deliver power supply to an application device and/or system demanding high pulsed power and/or requiring low operational temperature.

### BACKGROUND OF THE INVENTION

Energy storage devices can be used for a variety of applications such as a consumer electronic device, a vehicle, or an electrical grid; wherein the consumer electronic devices include, but not limited to: MP3 players, smartphones, tablets, laptop computers, smartwatches, activity trackers, and other wearable devices; wherein the vehicles include, but not limited to: hybrid electric buses, electric buses, hybrid electric cars, electric cars, electric bicycles, electric motorcycles, electric scooters, electric golf carts, trains, ships, airplanes, electric airplanes, helicopters, unmanned aerial vehicles, electric unmanned aerial vehicles, drones, other aerial vehicles, space stations, space shuttles, spaceplanes, satellites, unmanned spacecrafts, other spacecrafts, and other hybrid electric vehicles, plug-in hybrid electric vehicles, and electric vehicles; and wherein the electrical grid includes, but not limited to stand-alone micro-grids for residential homes, commercial buildings, and communities, and centralized electrical grids. Furthermore, such energy storage devices can be used for telecommunication systems, cellphone and antenna towers, data centers, and uninterruptable power supplies.

### SUMMARY OF THE INVENTION

As applications continue to require greater power and efficiency from energy sources such as batteries, techniques for improving solid-state thin film battery devices continue to be highly desired. The present invention includes a solid-state energy storage battery device configured to provide energy for various applications demanding high pulsed power and requiring low temperature start. Furthermore, the present invention includes a hybridized, integrated energy storage system to deliver power supply to an application device and/or system demanding high pulsed power and/or requiring low operational temperature.

In some embodiments, an integrated energy storage system comprises a first plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, fuel cells, capacitors, and supercapacitors, wherein the first plurality of energy storage units have a gravimetric energy density of greater than 180 Wh/kg and volumetric energy density greater than 450 Wh/L in an environmental temperature above 0° C.; a second plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, fuel cells, capacitors, and supercapacitors, wherein the second plurality of energy storage units have a gravimetric power density of greater than 450 W/kg and volumetric power density greater than 1080 W/L in an environmental temperature above 0° C.; a third plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, fuel cells, capacitors, and supercapacitors, wherein the third plurality of energy storage units are configured to operate in an environmental temperature as low as −100° C.; and a controller programmed to receive one or more inputs from one or more voltage sensors, one or more current sensors, and one or more temperature sensors, and to allocate the current or power among the first plurality of energy storage units, the second plurality of energy storage units, and the third plurality of energy storage units depending on a power consumption from an application load and an environmental temperature.

In some embodiments, the controller is programmed to allocate current or power from the second plurality of energy storage units depending on the power consumption from the application load, and the first plurality of energy storage units are configured to handle power to extend operational time. In some embodiments, the controller is programmed to allocate current or power to the third plurality of energy storage units when the environmental temperature is below a setpoint value, and the controller is configured to allocate current or power to at least the first plurality of energy storage units or the second plurality of energy storage units when the environmental temperature is above their operating temperature lower limit. In some embodiments, the first plurality of energy storage units have a gravimetric energy density greater than 200 Wh/kg and a volumetric energy density greater than 500 Wh/L in an environmental temperature above 0° C. In some embodiments, the second plurality of energy storage units have a gravimetric power density greater than 500 W/kg and a volumetric power density greater than 1200 W/L. In some embodiments, the third plurality of energy storage units are configured to operate in an environmental temperature as low as −100° C. In some embodiments, the controller is programmed to deliver power from the third plurality of energy storage units to at least the first plurality of energy storage units or second plurality of energy storage units to heat up at least the first plurality of energy storage units or the second plurality of energy storage units using resistive heating.

In some embodiments, the controller is programmed to use a detected voltage value from one or more voltage sensors, a detected current value from one or more current sensors, and a detected temperature from one or more temperature sensors to determine a state-of-charge or remaining capacity of at least the first plurality of energy storage units, the second plurality of energy storage units, or the third plurality of energy storage units. In some embodiments, the controller is programmed to use the determined state-of-charge or remaining capacity of at least the first plurality of energy storage units, the second plurality of energy storage units, or the third plurality of energy storage units to balance power deliver from the first plurality of energy storage units, the second plurality of energy storage units, and the third plurality of energy storage units. In some embodiments, the controller includes a charger configured to connect with an energy source to recharge the first plurality of energy storage units, the second plurality of energy storage units, and the third plurality of energy storage units. In some embodiments, the first plurality of energy storage units, the second plurality of energy storage units, and the third plurality of energy storage units are configured to be connected in series or in parallel to adjust the voltage of the system during charge and discharge.

In some embodiments, the present invention provides a energy storage battery device configured to provide high total energy for an application load with pulsed power, preferably a solid state energy storage battery device. The term solid-state is meant to include cells comprising a ceramic, glass, polymer or polymer-like electrolyte. The device can include at least two solid-state electrochemical cells, each electrochemical cell comprising at least an anode layer, an electrolyte layer, a cathode layer, a current collector layer, and a barrier layer. At least one of the solid-state electrochemical cells is characterized by a thinner cathode layer configured to supply energy for pulsed power consumption, with the cathode thickness ranging from 0.01 micrometers to 120 micrometers. At least one of the solid-state electrochemical cell is characterized by a thicker cathode layer configured to supply energy for baseline power consumption that is lower than the pulsed power, with the cathode thickness ranging from 0.05 micrometers to 360 micrometers and wherein the pulsed power is higher than baseline power consumed by the application load and lasts less than a minute.

In a some embodiments, a thickness of the thinner cathode layer and a thickness of the thicker cathode layer are determined by computer aided engineering to deliver the maximum energy for a given mass and/or volume and a given application load power consumption profile. An application load can be coupled to the device through a controller interface configured to detect the power consumption level from the load and allocate the majority or all of the discharge current and/or power to the thinner cathode electrochemical cell for detected high pulse power and to the thicker cathode electrochemical cell for detected low baseline power.

In some embodiments, the present invention can provide a solid-state energy storage battery device configured to provide energy for an application load during a low temperature start. The device can include at least two solid-state electrochemical cells, each electrochemical cell comprising at least an anode layer, an electrolyte layer, a cathode layer, a current collector layer, and a barrier layer. At least one of the solid-state electrochemical cells is characterized by a thinner cathode layer configured to supply energy in an environmental temperature of −100° C. to a setpoint value ranging from −50° C. to 50° C., with the cathode thickness ranging from 0.01 micrometers to 120 micrometers. At least one of the solid-state electrochemical cell is characterized by a thicker cathode layer configured to supply energy in an environmental temperature above a setpoint value ranging from −50° C. to 50° C., with the cathode thickness ranging from 0.05 micrometers to 360 micrometers.

In some embodiments, a thickness of the thinner cathode layer and a thickness of the thicker cathode layer are determined by computer aided engineering to deliver the maximum energy for a given mass and/or volume and a given environmental temperature. Also, an application load can be coupled to the device through a controller interface configured to detect the environmental temperature and allocate the majority or all of the discharge current and/or power to the thinner cathode electrochemical cell for detected low environmental temperature and to the thicker cathode electrochemical cell for detected higher environmental temperature. The thinner cathode electrochemical cell is configured to provide electric energy to heat the thicker cathode electrochemical cell by means of electrical heating when the environmental temperature is below a setpoint value ranging from −50° C. to 50° C. during a cold start.

The electrochemical cells or battery can be manufactured using at least physical vapor deposition (PVD) processes comprising PVD by thermal means, by e-beam heating, by resistance heating, by induction heating, by ion beam heating, by laser ablation, by molecular beam epitaxy, by Ion Beam Assisted Deposition (IBAD), by close coupled sublimation, by gas cluster ion beam; by physical vapor deposition by momentum transfer, by Diode sputtering, by magnetron sputtering, by unbalanced magnetron sputtering, by High power impulse magnetron sputtering, by RF Sputtering, by DC sputtering, by MF sputtering, by Cylindrical Sputtering, by Hollow Cathode Sputtering, by Sputter Evaporation, by Ion beam sputtering, by sputter ion cluster, by Bias Sputtering, by cathodic arc, by filtered cathodic arc; by reactive physical vapor deposition by background gas, by Ion Beam Assisted Deposition (IBAD), by Plasma activated PVD, and by combinations thereof. The electrochemical cells or battery can be manufactured using an aerosol deposition technique.

The device can include a charger coupled to the device, the charger configured to connect with an energy source to recharge the said device with either a constant current recharge profile, a constant current followed by constant voltage recharge profile, or a constant voltage recharge profile. Also, the device can be configured to provide energy to an application load from a consumer electronic device, a vehicle, or an electrical grid. Furthermore, such energy storage devices can be used for telecommunication systems, cellphone and antenna towers, data centers, and uninterruptable power supplies.

In some embodiments, the present invention provide a system to control a solid-state energy storage battery device having thinner cathode electrochemical cells and thicker cathode electrochemical cells designed for pulsed power loads and low temperature starts. The system can include at least a voltage sensor configured to monitor a voltage of the battery device, the voltage sensor comprising two or more voltage probes, at least a current sensor configured to monitor a current through the battery, the current sensor comprising two or more current probes, at least a temperature sensor configured to monitor a temperature of the battery, the temperature sensor comprising at least a temperature probe, at least a temperature sensor configured to monitor the environmental temperature, the temperature sensor comprising at least a temperature probe, and at least a controller configured to receive one or more inputs from the voltage sensors, the current sensors, and the temperature sensors, and to transmit a control signal to allocate the majority or all of the discharge current and/or power between the thinner cathode electrochemical cells and the thicker cathode electrochemical cells depending on a power consumption from the power load and an environmental temperature.

In some embodiments, the controller is configured to allocate the majority or all of a discharge current and/or power between the thinner and thicker cathode electrochemical cells; the majority or all of the discharge current and/or power being allocated to: thinner cathode electrochemical cell when the power consumption is higher during pulse power and/or when the environmental temperature is below a setpoint value ranging from −50° C. to 50° C. during a cold start; and thicker cathode electrochemical cell when the power consumption is lower during baseline power and/or when the environmental temperature is above a setpoint value ranging from −50° C. to 50° C.

In some embodiments, the controller is configured to partition an energy/power delivered from the thinner cathode electrochemical cells and to use part of the energy/power to heat up the thicker cathode electrochemical cells using resistive heating during a cold start when the environmental temperature is below a setpoint value; the temperature setpoint value ranging from −10° C. to 10° C. or −50° C. to 50° C.

In some embodiments, the controller is also configured to dynamically change the serial and/or parallel connections among the electrochemical cells and/or modules in the solid-state energy storage battery device to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging; wherein the different series-parallel connection configurations for battery cells and/or modules are achieved by configuring the on and off status of all the on-off switches; each battery cell and/or module being configured to be associated with six on-off switches to form a repeating group; the switches being transistors; the switches being field effect transistors including metal-oxide-semiconductor field effect transistors; the connection configurations being dynamically switched once the battery pack and/or module voltage falls below or rises above a setpoint value.

In some embodiments, the controller is configured to use a detected voltage value from the voltage sensor, a detected current value from the current sensor, and a detected temperature from the temperature sensor to determine a state-of-charge and remaining capacity of the thinner and thicker cathode electrochemical cells; wherein the controller is configured to determine the state of charge of the electrochemical cells using voltage look-up, coulomb counting, Kalman filtering, extended Kalman filtering, unscented transform based prediction-correction filtering; wherein the controller is configured to determine the state of charge of the electrochemical cells using physics-based battery models, equivalent circuit battery models, and other reduced-order battery models along with Kalman filtering, extended Kalman filtering, unscented transform based prediction-correction filtering; wherein the controller is configured to use the determined state-of-charge and remaining capacity of the thinner and thicker electrochemical cells to balance these cells based on a power load profile and the environmental temperature.

In some embodiments, the controller includes a charger configured to connect with an energy source to recharge the solid-state energy storage battery device with a constant current recharge profile, a constant current followed by constant voltage recharge profile, or a constant voltage recharge profile; wherein the controller is configured to provide a specified amount of charge current to the thinner cathode and thicker cathode electrochemical cells based on a nominal capacity of each of these respective cells.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 is a simplified graph illustrating a power profile for a solid-state energy storage battery device according to an embodiment of the present invention.

FIG. 2 is a simplified graph illustrating a discharge profile for a solid-state energy storage battery device according to an embodiment of the present invention.

FIG. 3 is a simplified diagram illustrating a cross-sectional view of a solid-state energy storage battery device according to an embodiment of the present invention.

FIG. 4 is a simplified graph illustrating a discharge profile for a solid-state energy storage thin battery cell according to an embodiment of the present invention.

FIG. 5 is a simplified graph illustrating a discharge profile for a solid-state energy storage thick battery cell according to an embodiment of the present invention.

FIG. 6 is a simplified graph illustrating performance of thin and thick battery cells according to an embodiment of the present invention.

FIG. 7 is a simplified circuit diagram illustrating an equivalent circuit for a load connection to a solid-state energy storage battery cell according to an embodiment of the present invention.

FIG. 8 is a simplified graph illustrating deliverable power to a system load from a solid-state energy storage battery cell according to an embodiment of the present invention.

FIG. 9 is a simplified circuit diagram illustrating an equivalent circuit for a load connection to a solid-state energy storage battery device with two serially connected cells according to an embodiment of the present invention.

FIG. 10 is a simplified graph illustrating deliverable power to a system load from a solid-state energy storage battery device with two serially connected cells according to an embodiment of the present invention.

FIG. 11 is a simplified diagram of a cross-sectional view of an electrochemical cell according to an embodiment of the present invention.

FIG. 12 is a simplified block diagram of a system for controlling solid-state battery devices according to an embodiment of the present invention.

FIG. 13 is a simplified graph illustrating deliverable energy per unit volume for Ni—Cd and Li-ion batteries for various temperatures according to an embodiment of the present invention.

FIG. 14A 14E are simplified diagrams illustrating the battery module serial-parallel connection configurations through the discharge of a battery pack according to various embodiments of the present invention.

FIG. 15A 15E are simplified diagrams illustrating the status of on-off switches to achieve the desirable battery module serial-parallel connection configurations through the discharge of a battery pack according to various embodiments of the present invention.

FIGS. 16A and 16B are simplified graphs illustrating the voltage response during a sinusoidal discharge and the convergence of estimated concentration at cathode and electrolyte interface using multiphysics based unscented transform prediction-correction filter according to an embodiment of the present invention.

### DETAILED DESCRIPTION OF THE INVENTION

Conventional battery devices struggle to address several key operational conditions. Some of these conditions include dealing with cold starts and pulse power. Current art teaches techniques such as keeping heaters operating all the time in order to maintain an operation battery pack temperature. Methods like these are quite energy inefficient.

Embodiments of the present invention address these issues by having a battery device configured using a hybrid design. This hybrid design uses thin cathode and thick cathode cells. Thin cathode cells are able to handle cold starts and may also be used to heat up thick cathode cells. Thin cathode cells are also able to handle pulse power. On the other hand, thick cathode cells are able to handle baseline power. By providing these cell types in a serially-connected design, the key operation conditions can be addressed while boosting the output voltage. Embodiments of the present invention further address these issues by having an energy storage system configured using a hybridized, integrated design. The system uses high-energy energy storage units, high-power energy storage units, and low-temperature energy storage units to deliver power supply to an application device and/or system demanding high pulsed power and/or requiring low operational temperature.

In some embodiments, a thickness of the thinner cathode layer is determined by computer aided engineering to deliver the maximum energy for a given mass and/or volume and a given application load power consumption profile and/or a given environmental temperature; wherein the thinner cathode layer has a thickness ranging from 0.01 micrometers to 100 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thinner cathode layer has a thickness ranging from 0.01 micrometers to 110 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LiₓMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thinner cathode layer has a thickness ranging from 0.01 micrometers to 120 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thinner cathode layer has a thickness ranging from 0.01 micrometers to 110 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thinner cathode layer has a thickness ranging from 0.01 micrometers to 100 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thinner cathode layer has a thickness ranging from 0.01 micrometers to 100 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

In some embodiments, a thickness of the thicker cathode layer is determined by computer aided engineering to deliver the maximum energy for a given mass and/or volume and a given application load power consumption profile and/or a given environmental temperature; wherein the thicker cathode layer has a thickness ranging from 0.05 micrometers to 300 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0<x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thicker cathode layer has a thickness ranging from 0.05 micrometers to 330 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0<x<2), and LiₓMn_{2+y)}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thicker cathode layer has a thickness ranging from 0.05 micrometers to 360 micrometers for cathode materials comprising cobalt oxides and their variations including CoO₂, LiCoO₂, LiₓCo_{1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thicker cathode layer has a thickness ranging from 0.05 micrometers to 330 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thicker cathode layer has a thickness ranging from 0.05 micrometers to 300 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎(M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thicker cathode layer has a thickness ranging from 0.05 micrometers to 300 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

In some embodiments, the electrochemical cells having thinner cathode layer can deliver gravimetric power density greater than 500 W/kg and volumetric power density greater than 1200 W/L; wherein electrochemical cells having thinner cathode layer can operate in an environmental temperature as low as −100° C.; wherein electrochemical cells having thicker cathode layer can deliver gravimetric energy density greater than 200 Wh/kg and volumetric energy density greater than 500 Wh/L; wherein electrochemical cells having thicker cathode layer can deliver gravimetric energy density greater than 180 Wh/kg and volumetric energy density greater than 450 Wh/L in an environmental temperature above 0° C.

In some embodiments, the solid-state energy storage device further comprise a controller interface configured to detect the power consumption level from a connected application load and allocate the majority or all of a discharge current and/or power to the thinner cathode electrochemical cell for detected high pulsed power and to the thicker cathode electrochemical cell for detected low baseline power; and further comprising a charger coupled to the device, the charger configured to connect with an energy source to recharge the said device with either a constant current recharge profile, a constant current followed by constant voltage recharge profile, or a constant voltage recharge profile.

In some embodiments, the solid-state energy storage device is configured to provide energy to an application load from a consumer electronic device, a vehicle, or an electrical grid; wherein the consumer electronic devices include, but not limited to: MP3 players, smartphones, tablets, laptop computers, smartwatches, activity trackers, and other wearable devices; wherein the vehicles include, but not limited to: hybrid electric buses, electric buses, hybrid electric cars, electric cars, electric bicycles, electric motorcycle, electric scooters, electric golf carts, trains, ships, airplanes, electric airplanes, helicopters, unmanned aerial vehicles, electric unmanned aerial vehicles, drones, other aerial vehicles, space stations, space shuttles, spaceplanes, satellites, unmanned spacecrafts, other spacecrafts, and other hybrid electric vehicles, plug-in hybrid electric vehicles, and electric vehicles; and wherein the electrical grid includes, but not limited to stand-alone micro-grids for residential homes, commercial buildings, and communities, and centralized electrical grids; the solid-state energy storage device is configured to provide energy to an application load for telecommunication systems, cellphone and antenna towers, data centers, and uninterruptable power supplies.

In a first example, the present invention can provide a solid-state energy storage battery device having a hybrid design of thin and thick cathode cells to meet pulse power requirements. In a specific embodiment, the dimensions of the battery device is specified as 7.2 cm×3.2 cm×0.5 cm, which is 7.2 cm long, 3.2 cm wide, and 0.5 cm thick. Other dimensions can be used depending on specified applications.

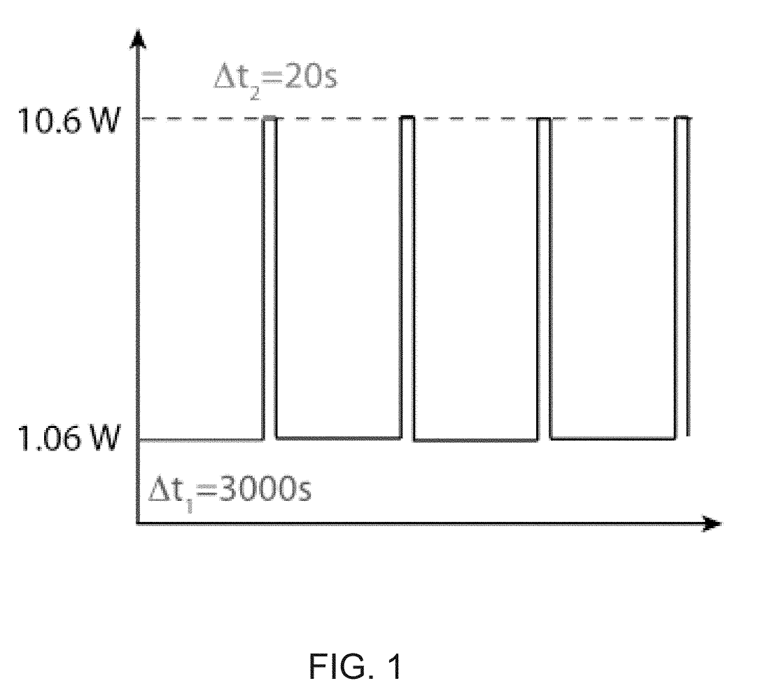

FIG. 1 is a simplified graph illustrating a power profile for a solid-state energy storage battery device according to an embodiment of the present invention. This profile can be representative of the previously described battery device of the first example. As shown in this graph, the baseline power is 1.06 W and the pulse power, excluding the baseline power, is 10.6 1.06=9.54 W. The pulse power of 10.6 W occurs every 3000 seconds (shown as t1) and lasts only 20 seconds (shown as t2).

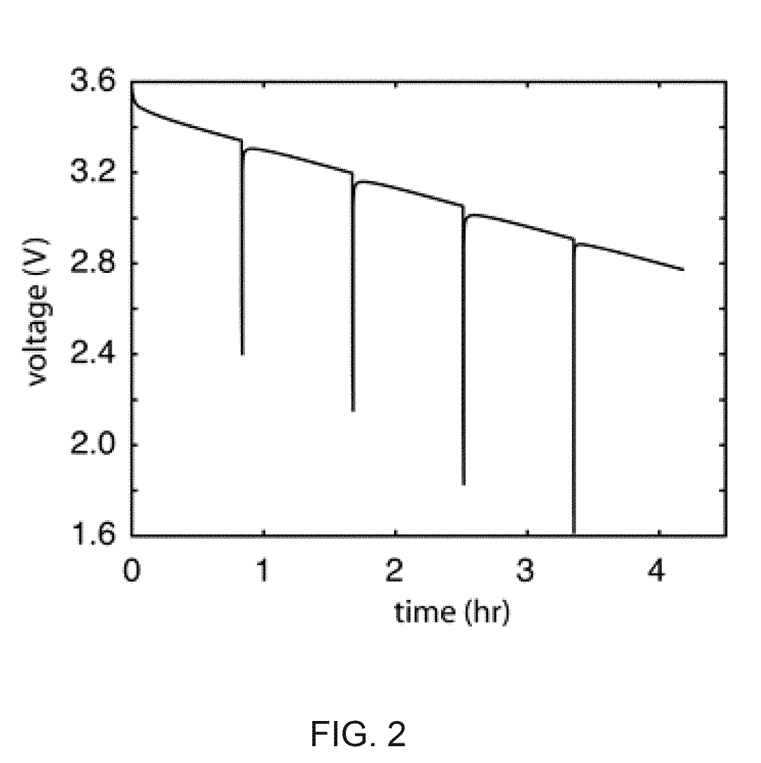

FIG. 2 is a simplified graph illustrating a discharge profile for a solid-state energy storage battery device according to an embodiment of the present invention. In a specific embodiment, this graph represents a discharge profile of a thick cathode battery design subjected to the given power demand from the previous figure. If a battery comprising electrochemical cells having 1.0 μm cathode and 0.4 μm electrolyte is used to supply power for the profile shown in FIG. 1, the battery can only last 4.2 hours before the battery reaches the discharge cut-off voltage of 1.5 V, as shown in FIG. 2.

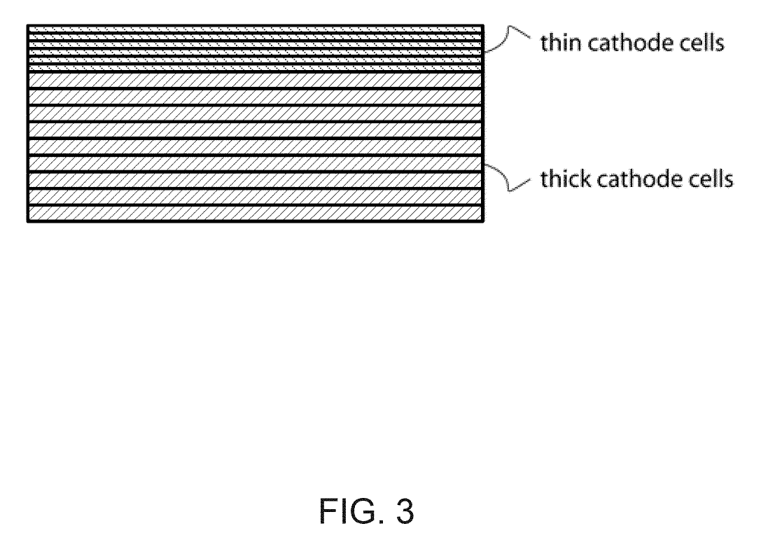

However, if a hybrid design of a battery includes both thin and thick cathode cells, then the baseline power can be provided by the thick cathode electrochemical cells and the pulse power can be provided by the thin cathode electrochemical cells. The specified total volume available for the battery can be partitioned into two slots for thin and thick cathode cells, respectively. In a specific embodiment, the thin cathode cells are assigned with the partitioned volume of 7.2 cm×3.2 cm×0.1 cm and the thick cathode cells are assigned with the volume of 7.2 cm×3.2 cm×0.4 cm, which is shown in FIG. 3.

FIG. 3 is a simplified diagram illustrating a cross-sectional view of a solid-state energy storage battery device according to an embodiment of the present invention. This figure can illustrate an embodiment of the hybrid design having thin and thick cathode cells as described previously. In other words, 80% of the total available volume is assigned to thick cathode cells to provide a baseline power of 1.06 W constantly, and 20% of the total available volume is assigned to thin cathode cells to provide a pulse power (excluding the baseline power of 1.06 W) of 9.54 W. In a specific embodiment, the cathode thickness in the thin cathode cell is 0.2 μm and the cathode thickness in the thick cathode cell is 1.0 μm. The electrolyte thickness for both thin and thick cells is 0.4 μm.

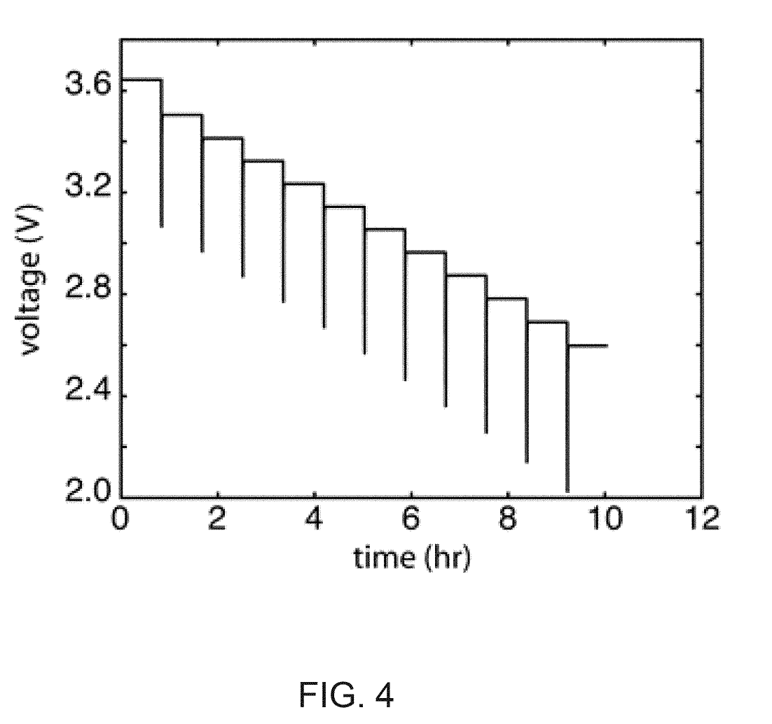

FIG. 4 is a simplified graph illustrating a discharge profile for a solid-state energy storage thin battery cell according to an embodiment of the present invention. If the battery using the hybrid deign of thin and thick cathode cells is used to provide the power according to the profile of FIG. 1, the thin cathode cell delivers the high pulse power for 10 hours before the voltage reaches 2 V, as shown in FIG. 4. This is still above the cut-off voltage of 1.5 V.

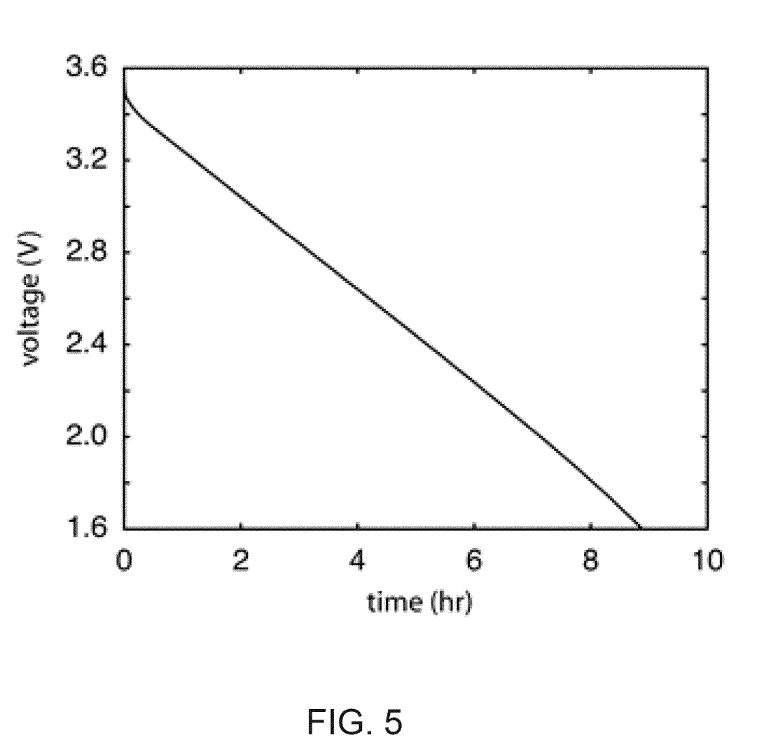

FIG. 5 is a simplified graph illustrating a discharge profile for a solid-state energy storage thick battery cell according to an embodiment of the present invention. The thick cathode cell delivers the baseline power for 8.9 hours before the voltage reaches 1.6 V, as shown in FIG. 5. This is still above the cut-off voltage of 1.5V. The hybrid cattery design of thin and thick cathode cells lasts more than 8.9 hours for the given power demand, while the single thick cathode cell battery design only lasts 4.2 hours for the same given power demand. The hybrid design of thin and thick cathode cells provides a clear advantage for pulse power demands. This improvement in performance is one of the benefits that can be achieved via embodiments of the present invention.

In a second example, the present invention can provide a solid-state energy storage battery device using computer simulation projected optimized high power cell cathode thickness. In this example, the volume partition ratio between thin and thick cathode cells is identified so that the end-of-discharge times for both thin and thick cathode cells are matched as closely as possible. This is done for several different thin cathode thicknesses, including 0.1 μm, 0.2 μm, and 0.3 μm.

TABLE 1
Identified volume partition ratios for different thin
cathode thicknesses and the resulting end-of-discharge
time for high power and high energy cells

| High power | Optimal volume | Operational time | Operational time |
|---|---|---|---|
| cell cathode | for High Power | for high power | for high energy |
| thickness | Cells | cell | cell |
| 0.1 μm | 19.2% | 9.23 hrs | 9.37 hrs |
| 0.2 μm | 17.5% | 10.1 hrs | 9.61 hrs |
| 0.3 μm | 19.5% | 10.1 hrs | 9.33 hrs |

As shown in Table 1, if the thin cathode thickness uses 0.1 μm and delivers high pulse power, the optimal volume assigned for the high power cells of the thin cathode is 19.2%. The resulting operational time is 9.23 hours for high power cell (thin cathode cell), and the resulting operational time is 9.37 hours for high energy cell (thick cathode cell). This table shows that having a thin cathode thickness of 0.2 μm with 17.5% of volume assigned yields the longest combined operational time of 9.61 hours among the three different thin cathode thickness designs compared above.

In a third example, the present invention can provide a solid-state energy storage battery device using computer simulation projected gravimetric energy density of thin and thick cathode electrochemical cells at different temperatures. This example shows the advantage of thin cathode cells during a cold start. In this case, the thin cathode thickness is 0.3 μm and the thick cathode thickness is 1.0 μm. Both cells are discharged at C/2 under various environmental temperatures.

In an embodiment, the present invention provides a solid-state energy storage battery device configured to provide energy for an application load during a low temperature start, the device comprising: at least two solid-state electrochemical cells, each electrochemical cell comprising at least an anode layer, an electrolyte layer, a cathode layer, a current collector layer, and a barrier layer; wherein at least one of the solid-state electrochemical cells is characterized by a thinner cathode layer configured to supply energy in an environmental temperature of −100° C. to a setpoint value ranging from −50° C. to 50° C., the cathode thickness ranging from 0.01 micrometers to 120 micrometers; wherein at least one of the solid-state electrochemical cell is characterized by a thicker cathode layer configured to supply energy in an environmental temperature above a setpoint value ranging from −50° C. to 50° C., the cathode thickness ranging from 0.05 micrometers to 360 micrometers.

In a some embodiments, the solid-state energy storage device further comprises a plurality of thinner and thicker cathode battery cells or a battery pack comprising a plurality of battery modules with each module comprising a plurality of thinner and thicker cathode battery cells.

In some embodiments, the solid-state energy storage device further comprises a plurality of battery modules connected in series, in parallel or a combination thereof; wherein the battery module comprising a plurality of battery cells connected in series, in parallel or a combination thereof; the device further comprises a plurality of battery cells connected in series, in parallel or a combination thereof, wherein the serial and/or parallel connection among battery cells are dynamically changed to adjust the voltage of the device during charge and discharge; the device further comprises a plurality of battery modules connected in series, in parallel or a combination thereof; wherein the serial and/or parallel connection among battery modules are dynamically changed to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging; wherein the different series-parallel connection configurations for battery cells and/or modules are achieved by configuring the on and off status of all the on-off switches; each battery cell and/or module being configured to be associated with six on-off switches to form a repeating group; the switches being transistors; the switches being field effect transistors including metal-oxide-semiconductor field effect transistors; the connection configurations being dynamically switched once the battery pack and/or module voltage falls below or rises above a setpoint value.

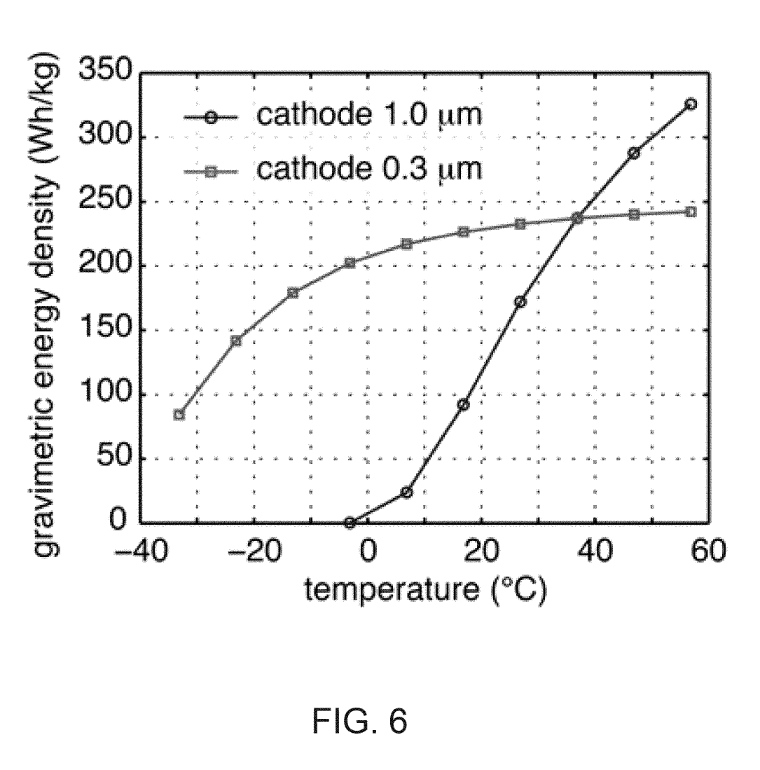

FIG. 6 is a simplified graph illustrating performance of thin and thick battery cells according to an embodiment of the present invention. Specifically, this figure depicts the performance of thin and thick battery cells according to conditions of the third example. FIG. 6 shows that the achievable energy measured by gravimetric energy density (energy per unit mass, Wh/kg) depends strongly on temperature and cathode thickness. To deliver acceptable energy under cold environmental temperature (below 0° C.), a thin cathode cell has to be used. Therefore, a hybrid battery design of thin and thick cathode cells is capable of delivering the required energy/power during cold start with the required energy/power provided by the thin cathode cell only.

In a fourth example, the present invention can provide a solid-state energy storage battery device using two serially connected cells to deliver required power. Another approach to deliver pulse power is to connect battery cells in serial to increase the output voltage of the battery. Sometimes, a single battery cannot even deliver the required power because of the required higher discharge current and the existing power path resistance between the battery and the application due to safety circuits, connectors, and other circuit boards.

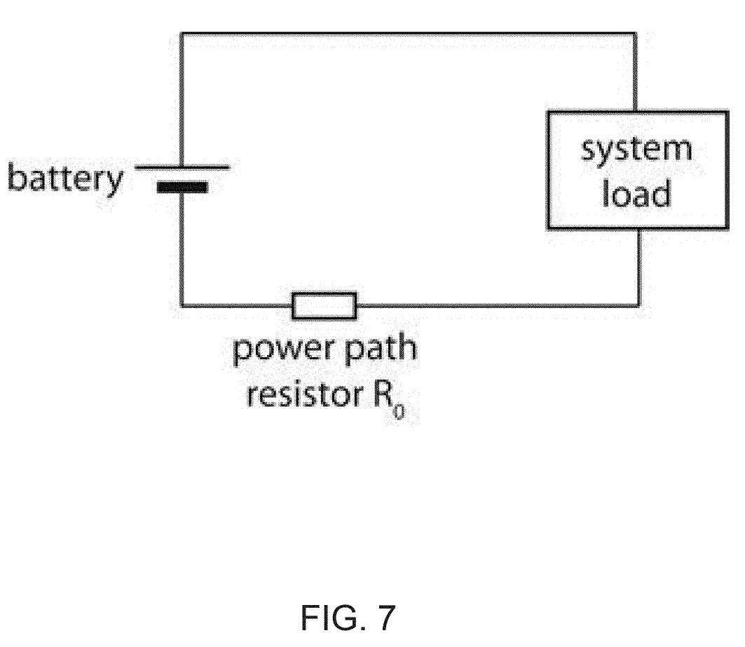

FIG. 7 is a simplified circuit diagram illustrating an equivalent circuit for a load connection to a solid-state energy storage battery cell according to an embodiment of the present invention. In a specific embodiment, the present invention can include a battery device having a specified volume of 6 cm×12.3 cm×0.49 cm, assuming that the power path resistor between the battery and the point of power consumption is 150 mΩ, the battery is required to deliver 10 W pulse power to the load. As shown in FIG. 7, the circuit diagram shows the battery, power path resistor, and system load.

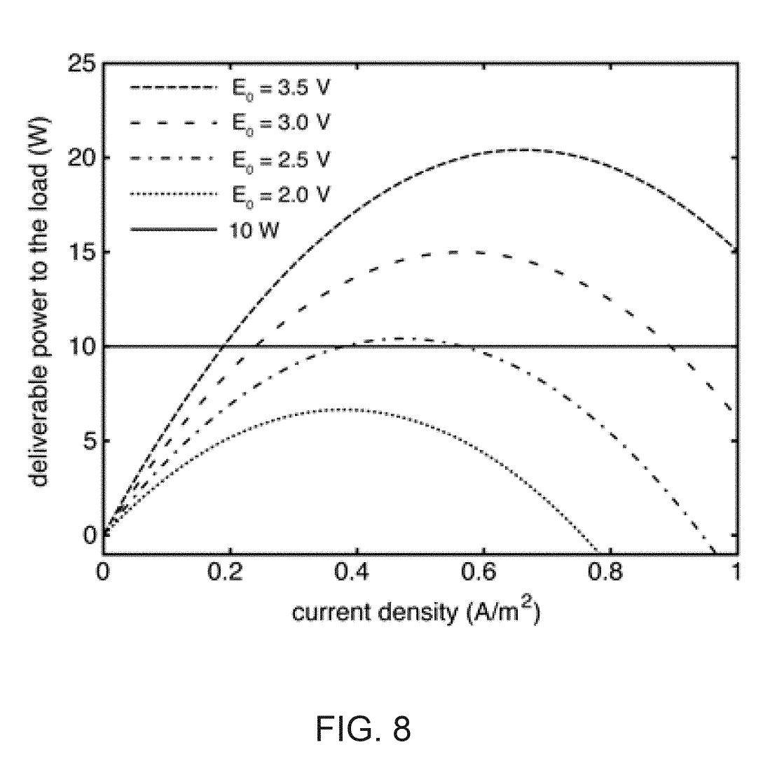

FIG. 8 is a simplified graph illustrating deliverable power to a system load from a solid-state energy storage battery cell according to an embodiment of the present invention. FIG. 8 shows the deliverable power versus discharge current density (current per unit area) for different open circuit voltage (E₀) of the single battery, assuming that the internal resistance of the battery is negligible comparing the power path resistance. It is shown that for open circuit voltages 2.5 V, 3.0 V, and 3.5 V, the battery can still deliver 10 W pulse power to the load with properly adjusted discharge current density. However, 10 W pulse powers can never be delivered to the load when the battery open circuit voltage drops to 2.0 V (which is still above the battery discharge cut-off of 1.5 V for this case) regardless of the value assumed by the discharge current density.

In a some embodiments, two battery cells can be connected in series with each cell occupying half of the total volume assigned for the battery device in an application in order to deliver high pulse power. The output voltage of two serially connected cells is higher, and the required current to deliver the same power is smaller. Consequently, the power loss at the power path resistor is smaller. Therefore, more power can be delivered directly to the application system load.

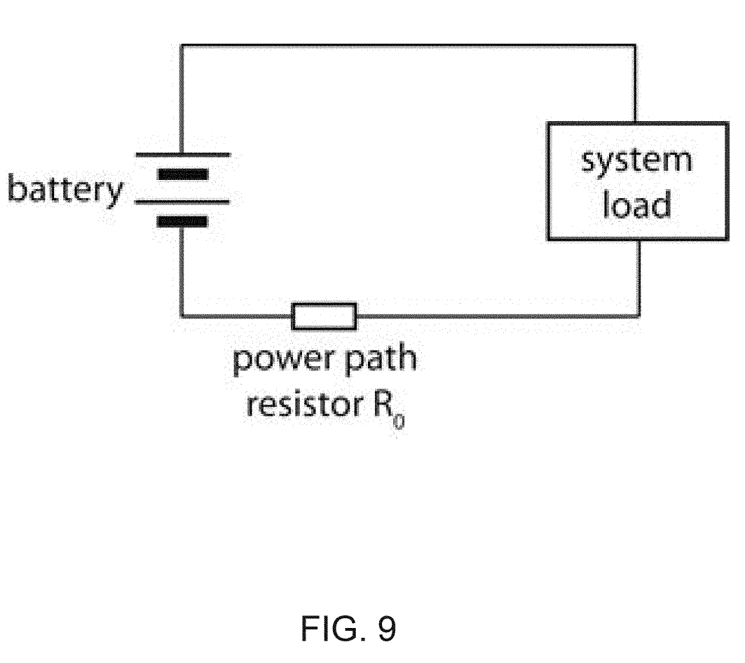

FIG. 9 is a simplified circuit diagram illustrating an equivalent circuit for a load connection to a solid-state energy storage battery device with two serially connected cells according to an embodiment of the present invention. This figure depicts the corresponding serially connected battery cells, described previously, along with the power path resistor and system load.

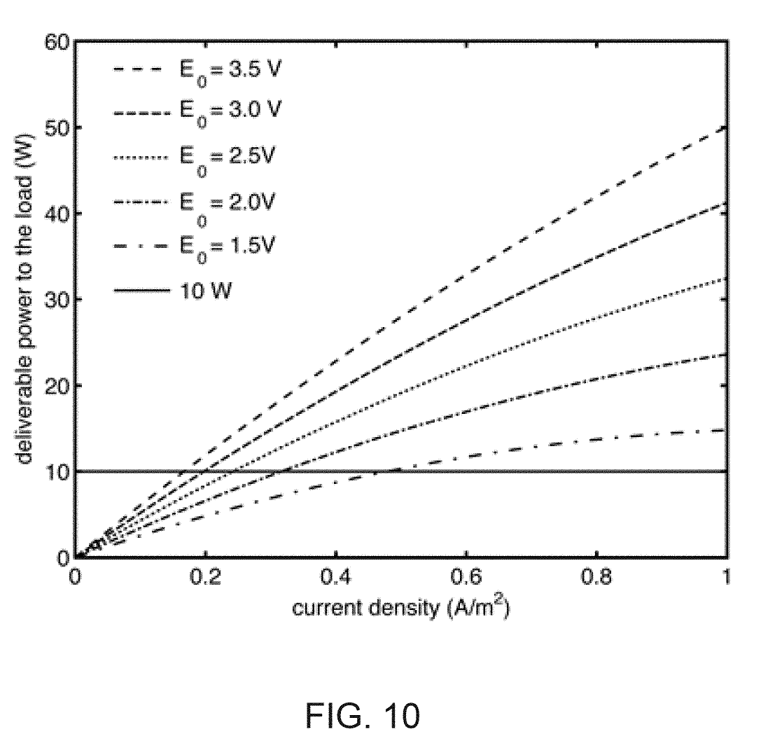

FIG. 10 is a simplified graph illustrating deliverable power to a system load from a solid-state energy storage battery device with two serially connected cells according to an embodiment of the present invention. As shown in FIG. 10, two serially connected cells can deliver power higher than 10 W with properly selected discharge current density values, even when the open circuit voltage drops to the cut-off value of 1.5V.

In a fifth example, the present invention can provide a solid-state energy storage battery device using computer simulation obtained cathode thickness optimization to deliver more energy for a given power consumption profile. In a specific embodiment, two cells are connected in serial to boost the output voltage and meet the required power. These two cells are identical and each cell occupies half of the total battery volume. For a given power demand profile, the cathode thickness for the cells is optimized such that the battery comprising two battery cells deliver the maximum energy.

TABLE 2
High throughput simulation of battery output energy at different
cathode thicknesses and cathode thickness optimization

| | Cathode | End of discharge | Equivalent |
|---|---|---|---|
| Simulation | thickness | time of battery | Energy |
| case | (μm) | (hr) | (Wh) |
| 1 | 0.50 | 5.14 | 26.7 |
| 2 | 0.55 | 5.26 | 27.4 |
| 3 | 0.60 | 5.35 | 27.8 |
| 4 | 0.65 | 5.40 | 28.1 |
| 5 | 0.70 | 5.41 | 28.2 |
| 6 | 0.75 | 5.41 | 28.1 |
| 7 | 0.80 | 5.37 | 27.9 |

As shown above in Table 2, cathode thickness affects the energy output of the designed battery, and the optimal cathode thickness for the given power profile is 0.7 μm. The same method of using computer simulation can be used to determine the optimal cathode thickness, or thickness of another electrochemical cell layer, for any given power profile.

In a sixth example, the present invention can provide a solid-state energy storage battery device using computer simulation projected battery performance against one commercially available battery performance.

TABLE 3
Comparison of packaged battery energy
for different power demand cases

| | | | Equivalent Battery Energy (in Wh) | | |
|---|---|---|---|---|---|
| | Cathode | | at Different Bare Cell to Packaged | | |
| | Thick- | Discharge | Battery Volume Ratios | | |
| | ness | Time | Ratio = | Ratio = | Ratio = |
| | (μm) | (hr) | 100% | 85% | 70% |
| Battery for | 0.65 | 5.59 | 26.5 Wh | 22.5 Wh | 18.6 Wh |
| Power demand | | | | | |
| Case #1 | | | | | |
| Battery for | 0.70 | 5.41 | 28.2 Wh | 24.0 Wh | 19.7 Wh |
| Power demand | | | | | |
| Case #2 | | | | | |

| | | | |
|---|---|---|---|
| COMPETITOR | — | — | 14.8 Wh |
| (Nominal) | | | |

In this example, the optimal cathode thickness is slightly different for different power demand cases, which results in different battery output energy. This is shown above in Table 3. If a bare cell to the packaged battery volume ratio of 85% is assumed, the total energy of the packaged battery is 22.5 Wh and 24.9 Wh for the two designs, respectively. Both of these cases shown significant improvement over a conventional battery device, such as the competitor battery with 14.8 Wh energy shown in the table.

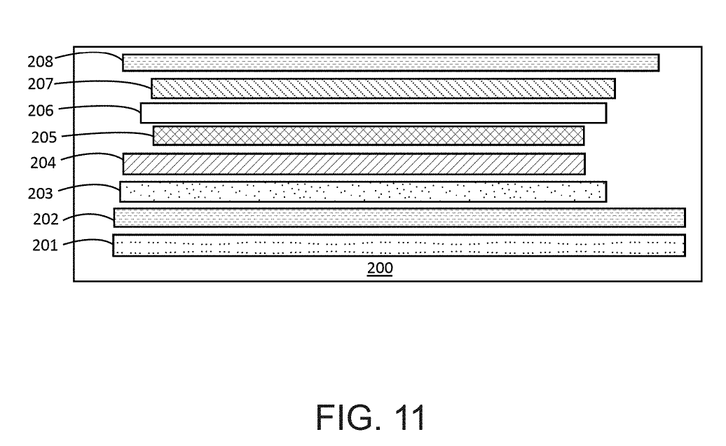

FIG. 11 is a simplified diagram of a cross-sectional view of an electrochemical cell according to an embodiment of the present invention. In an embodiment, the smallest unit in thin-film solid-state lithium batteries is comprised of a substrate 201, cathode barrier 202, cathode current collector 203, cathode 204, electrolyte 205, anode 206, anode current collector 207, anode barrier layer 208 in sequence as illustrated in FIG. 11. The cathode barrier layer 202, cathode current collector 203, cathode 204, electrolyte 205, anode 206, anode current collector 207, and anode barrier 208 are deposited on top of substrate layer 201 by using physical vapor deposition techniques.

Physical vapor deposition (PVD) processes, often called thin-film processes, are atomistic deposition processes in which materials is vaporized from solid or liquid source material in the form of atoms or molecules, transported in the form of a vapor through a vacuum or low pressure gaseous plasma chamber to the substrate where it condenses to form the film layer material. Here, the term “thin film” is applied to layers that have thicknesses on the order of several micrometers or less. PVD processes can be sued to deposit films of elements and alloys as well as compounds using reactive deposition processes. The resulting films can range from single crystal to amorphous, fully dense to less than fully dense, pure to impure, and thin to thick. In order to maximize the energy density of battery device in a specific embodiment, the mathematical model is used to facilitate this.

The substrate layer 201 in the thin-film solid-state electrochemical cell provides the mechanical support for the following layers. Therefore, it must to have the stiffness to sustain the induced weight and stresses due to the following deposited layers latter on. Therefore, typical substrate will be thick and stiff material. The substrate may be a thin film metal substrate of a thickness of 6 microns or less, preferably of a thickness of 2 microns or less. The thin film metal substrate may be a ribbon of metal foil having a longitudinal length, the battery device comprising a plurality of solid-state electrochemical cells deposited along the longitudinal length, and wherein the distance between adjacent solid-state electrochemical cells deposited on the ribbon substrate increases in a direction of the longitudinal length of the substrate. Conversely, a thin polymer, especially the polyethylene terephthalate (PET), can be used as a substrate, in which the substrate thickness is less than 10 microns. The PET can be used to reduce parasitic mass of the battery device, although undesired materials can leach into or out from a polymer substrate. In order to prevent oxygen and moisture from a PET substrate diffusing into cathode and cathode current collector, a metallized PET, which a very thin layer of copper can be coated above the PET. This increases the mass of the battery device, but can reduce the impurity of the cathode and extend its longevity. The thickness of the metalized metal on PET is in the order Angstrom meters.

The cathode barrier layer 202 between the substrate and cathode current collector of the device in a specific embodiment is used to inhibit the reaction of lithium with the moisture inside substrate. Organic materials can be used for this function. An oxide, nitride, or phosphate of metal is preferable for this layer. The metal comes from Groups 4, 10, 11, 13 and 14 of the periodic table. These metal oxides, metal nitrides, or metal phosphates are easy to evaporate and deposit. In a specific embodiment, the thickness of this layer is on the order of 0.1 microns or less. One of promising candidates is the lithium phosphate (LiₓPO_{y} where x+y<=7).

The cathode 203 and anode current collectors 207 in this device are necessary to collect and transport the electron current from the cathode toward the external load. Hence, it needs to have high electrical conductivity, which is in the order of 10⁷ S/m or higher. The cathode and anode current collectors need to be chemical stable at the voltage where they are operated. The cathode current collector needs to be stable at the range of 1.5 to 5 V vs. lithium, and anode current collector needs to be stable at range 0 to 1V versus lithium. Although the current collector is necessary in the electrochemical cell to transport the electrons, it does not contribute the electronic energy of the cell. Hence, it needs to be thin to reduce the volume and mass; however, it cannot be too thin. The potential drop through the film is depending of the thickness of the film as,

$$φ ( x = L ) = \frac{{iL}^{2}}{2 σ H}$$

where L is the length of the film, H is the thickness of the film, and a is the electrical conductivity of the film. Therefore, the thickness cannot be lower than certain value to minimize the potential drop across the film. In a specific embodiment, the thickness of the current collector is between about 0.1 and about 2 microns.

In this device, a cathode electrode material 204 comprised of amorphous or crystalline lithiated transition metal oxide and lithiated transition metal phosphate, wherein the metal comes from Groups 3 to 12 of the periodic table, preferably amorphous lithiated vanadium based oxide with electrical conductivity ranging from 10⁻⁶ to 10⁻² S/m (preferably more than 10⁻³ S/m), and ionic diffusivity ranging 1×10⁻¹⁶ to 1×10⁻¹⁴ m²/s. The vanadium based oxide overlying the electrically conductive layer, the cathode electrode material being characterized with a layer thickness between about 0.2 and about 2 micrometers. The electrical conductivity can be adjusted by the process condition in a specific embodiment.

The solid-state glassy electrolyte 205 of this device comprises amorphous lithiated oxynitride phosphorus with ionic conductivity ranging from 10⁻⁵ to 10⁻³ S/m. The ionic conductivity of glassy electrolyte can be tuned by the nitrogen concentration and evaporation process conditions. This glassy electrolyte material configured as an electrolyte overlying the cathode electrode material, the glassy electrolyte material being capable of shuttling lithium ions during a charge process and a discharge process, the glassy electrode material characterized with layer thickness between about 0.1 and about 1 micrometers.

A solid-state layer of negative electrode material configured as an anode 206 in this device is capable of electrochemically insertion lithium into the host lattice or plating of Li-ions during a charge process and a discharge process. This solid-state anode layer having layer thickness between about 0.2 and about 3 micrometers, which has to been about several times of cathode capacity so that it could ensure enough lithium concentration for shuttling back and forth between cathode and anode through electrolyte.

The anode barrier layer 208 overlies the anode current collector in this device is used to inhibit the reaction of lithium with the moisture external air. Organic materials can be used for this function. An oxide, nitride, or phosphate of metal is preferable for this layer. The metal comes from Groups 4, 10, 11, 13 and 14 of the periodic table. These metal oxides, metal nitrides, or metal phosphates are easy to evaporate and deposit. In an embodiment, the thickness of this layer is in the order of 0.1 microns or less. One of promising candidates is the lithium phosphate (LiₓPO_{y} where x+y<=7).

In a specific embodiment, the electrochemical cells are formed by physical vapor deposition techniques in the sequence of barrier-cathode current collector-cathode-electrolyte-anode-anode current collector-anode barrier repeated more than 100 times, but less than 3000 times, and in the sequence of cathode current collector-cathode-electrolyte-anode-anode current collector-anode-electrolyte-cathode-cathode current collector repeatedly more than 2 times of this sequence on top of substrate layer to reduce the number of layers of substrate and increase the volumetric energy density of the solid-state lithium battery. Those of ordinary skill in the art will recognize other variations, modifications, and alternatives.

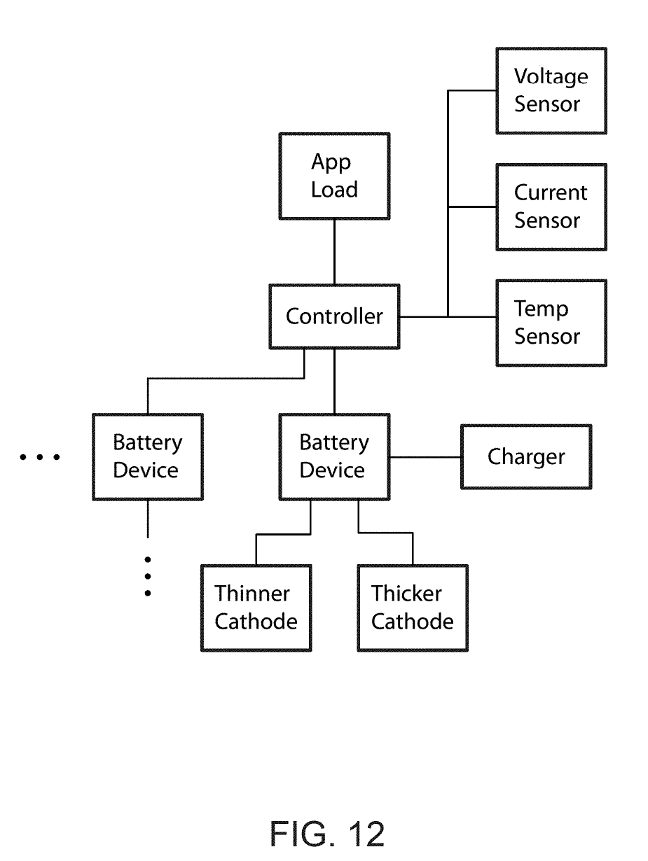

FIG. 12 is a simplified block diagram of a system for controlling solid-state battery devices according to an embodiment of the present invention. This figure shows an example configuration of a system to control solid-state energy storage battery devices. As shown, the battery device has thinner and thicker cathode electrochemical cells. The device is connected to a controller, which is connected to an application load or power load, multiple sensors (voltage, current, and temperature), and a charge. More than one battery device can be coupled to the controller and a plurality of battery devices can be configured as a module or pack.

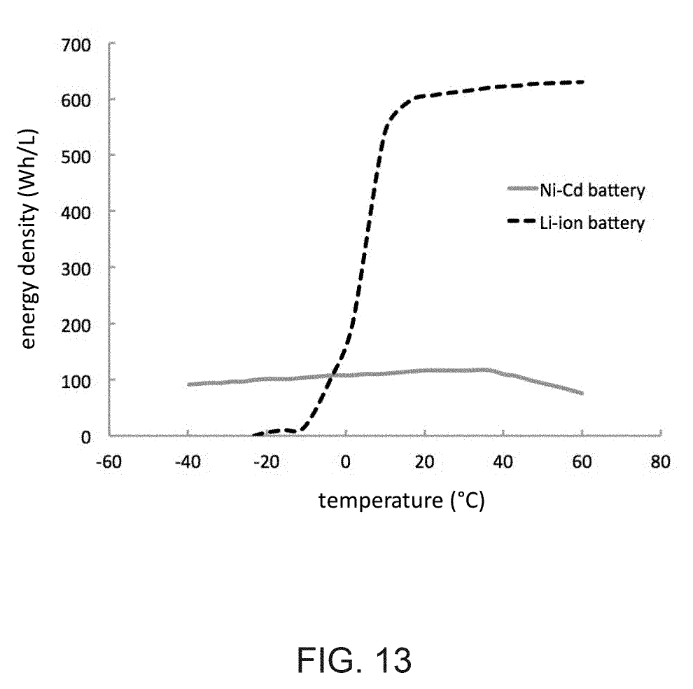

In a seventh example, Ni—Cd batteries are used for low temperature operation and heat Lithium ion batteries during a cold start. FIG. 13 shows the energy density of two different electrochemical systems at various temperatures. Li-ion batteries have the advantage of much higher energy density, but they are limited by higher operating temperature. Ni—Cd batteries have much lower energy density but they have extremely wide operating temperature range, especially at low temperature. To design a battery system for electric vehicle application, one needs to consider the maximum energy output under the constraint of total battery pack volume and weight as well as electric vehicle cold start capability under low environmental temperature.

In this example, a worst-case scenario is assumed that the battery pack needs to operate normally at −40° C. Therefore, a hybridized energy storage system solution is designed to utilize high energy density of Li-ion batteries and wide operating range of Ni—Cd batteries. Table 4 shows the effective material properties of the two batteries. The energy is delivered from Ni—Cd batteries between −40 to 0° C. to heat up the whole battery pack. Once the battery pack is warmed up to 0° C., both Ni—Cd and Li-ion batteries are discharged to deliver energy and power to the electric motor to drive the vehicle. It is shown that a hybrid battery design with 29% volume ratio of Ni—Cd and 71% volume ratio of Li-ion can achieve the maximum energy output after exclusively using energy of Ni—Cd battery to heat up the whole pack from −40 to 0° C.

TABLE 4
Effective Material Properties of Batteries

| Effective material property | Ni—Cd battery | Li-ion battery |
|---|---|---|
| Mass density (kg/m³) | 4200 | 1700 |
| Specific heat (J/K · kg) | 830 | 1320 |

In an eighth example, six on-off switches are connected to each of 10 battery modules and are dynamically switched and configured to keep the output voltage of a battery pack above 300 V. In this example, a battery pack has 10 battery modules, with each module containing 23 thinner cathode electrochemical cells and 23 thicker cathode electrochemical cells. Inside each battery module, one thinner cathode electrochemical cell and one thicker cathode electrochemical cell are first connected in parallel to form a basic battery group. There are 23 such battery groups connected in series to form a battery module. The serial-parallel connection configurations among the 10 battery modules are dynamically switched during the course of discharge to adjust the output voltage of the battery pack such that the output voltage is above 300 V. The switching of the serial-parallel connection configurations are achieved by turning on and off the six on-off switches connected to one battery module.

To illustrate how serial-parallel connection configuration changes during discharge, it is assumed that the voltage of a battery group, which is made of one thinner cathode cell and one thicker cathode cell connected in parallel, changes over time and with discharge current as:

V_{group}=3.7−0.0314It−0.0015I

where V_{group} is output voltage for the battery group in Volt, I is the discharge current for the battery group in Ampere, and t is time in hour.

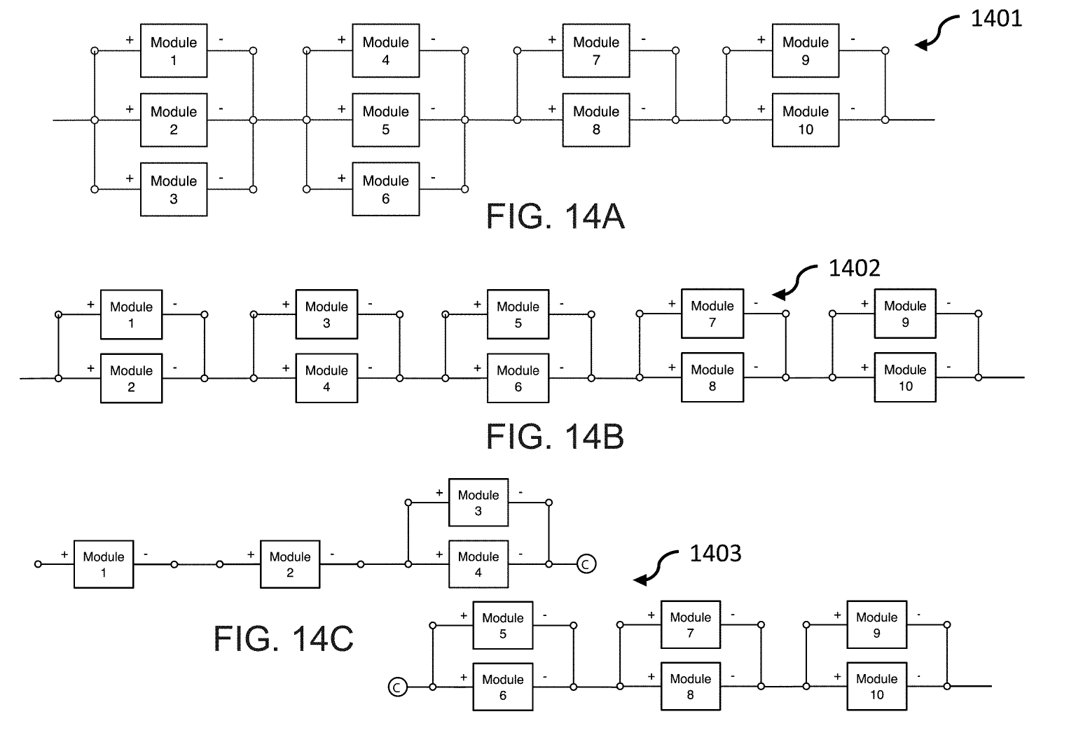

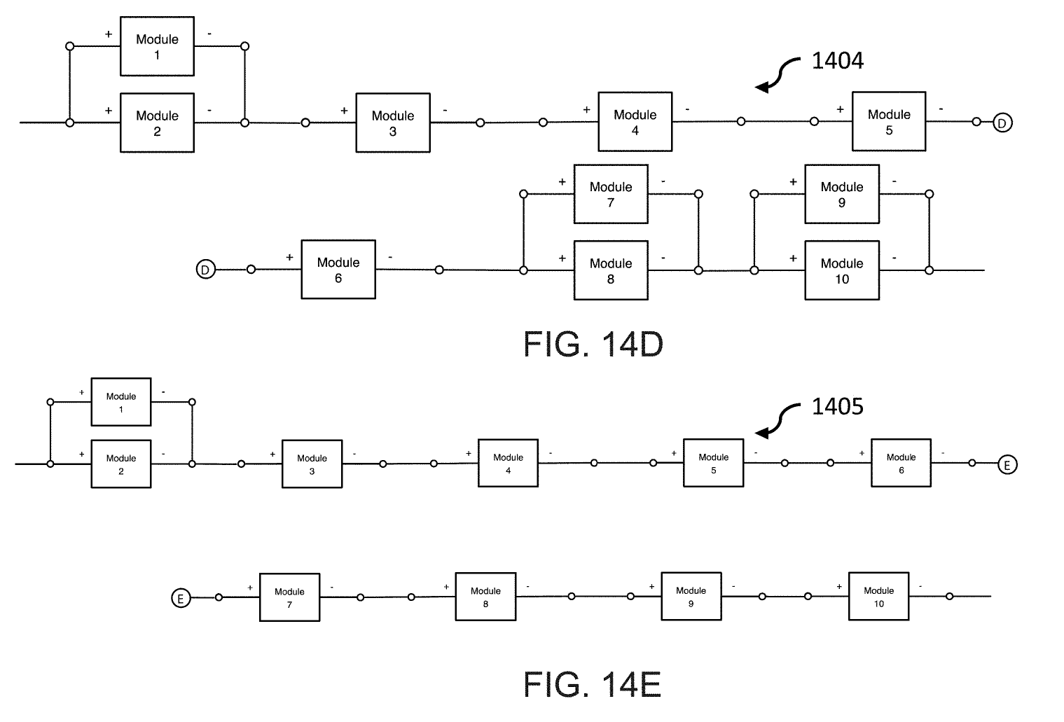

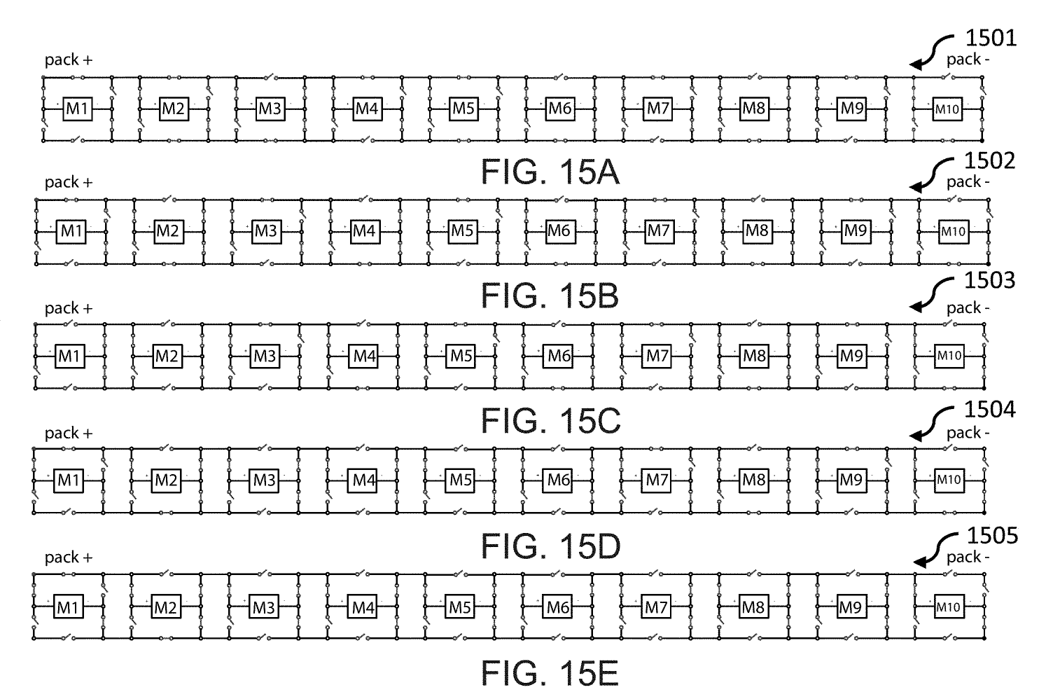

FIGS. 14A-14E is a simplified diagram illustrating the battery module serial-parallel connection configurations through the discharge of a battery pack according to an embodiment of the present invention. These serial-parallel configurations can be an example of the battery pack described in the eighth example described above. Also, FIG. 15 is a simplified diagram illustrating the status of on-off switches to achieve the desirable battery module serial-parallel connection configurations through the discharge of a battery pack according to an embodiment of the present invention. These are the dynamic switches used to adjust the output voltage of the battery pack, as in the eighth example.

At the beginning of the discharge, the serial-parallel connection configuration, configuration 1, is set as 1401 in FIG. 14A, and the configuration is achieved by setting the on-off status of switches as 1501 in FIG. 15A. In this configuration, module 1, 2, and 3 are connected in parallel; module 4, 5, and 6 are connected in parallel; module 7 and 8 are connected in parallel; module 9 and 10 are connected in parallel; these groups of parallel connected modules are further connected in series. Configuration 1 is designated by -3-3-2-2-. At t=0 hr, the battery pack voltage is 337 V. The battery pack is discharged by a current of 50 A. The discharge phase 1 with serial-parallel connection configuration 1 ends at t=0.62 hr when the pack voltage reaches 300 V. At t=0.62 hr, the connection configuration among the modules is switched to configuration 2, as 1402 in FIG. 14B, and this configuration is achieved by setting the on-off status of switches as 1502 in FIG. 15B. Configuration 2 is designated by -2-2-2-2-2-. With the new serial-parallel connection configuration for the modules, the battery pack voltage is 376 V. The battery pack is discharge continuously with 50 A until t=1.47 hr when the battery pack voltage reaches 300 V. This is discharge phase 2, from 0.62 hr to 1.47 hr. The battery pack is discharged subsequently with phase 3 in configuration 3 as illustrated by 1403 in FIG. 14C (node ‘C’ connecting the two parts of the configuration) and 1503 in FIG. 15C, phase 4 in configuration 4 as illustrated by 1404 in FIG. 14D (node ‘D’ connecting the two parts of the configuration) and 1504 in FIG. 15D, and phase 5 in configuration 5 as illustrated by 1405 in FIG. 14E (node ‘E’ connecting the two parts of the configuration) and 1505 in FIG. 15E. The corresponding time and voltages for each discharge phase is listed in detail in Table 5. It is shown that, by dynamically switching the serial-parallel connection configurations for modules, the output voltage of the pack is kept above the targeted value of 300 V.

TABLE 5
Battery Pack Voltage During Different Discharge Phases With Different Serial-
Parallel Connection Configurations For Modules

| | | | | | Pack | Pack | Pack | Pack |
|---|---|---|---|---|---|---|---|---|
| Discharge | Connection | Discharge | Phase | Phase | Voltage | Voltage | Power | Power |
| Phase | Configuration | Current | End Time | Duration | High | Low | High | Low |
| 1 | 1 | 50 A | 0.62 hr | 0.62 hr | 337 V | 300 V | 16.9 kW | 15.0 kW |
| | (-3-3-2-2-) | | | | | | | |
| 2 | 2 | 50 A | 1.47 hr | 0.84 hr | 376 V | 300 V | 18.8 kW | 15.0 kW |
| | (-2-2-2-2-2-) | | | | | | | |
| 3 | 3 | 50 A | 1.88 hr | 0.41 hr | 360 V | 300 V | 18.0 kW | 15.0 kW |
| | (-1-1-2-2-2-2-) | | | | | | | |
| 4 | 4 | 50 A | 2.18 hr | 0.30 hr | 360 V | 300 V | 18.0 kW | 15.0 kW |
| | (-2-1-1-1-1-2-2-) | | | | | | | |
| 5 | 5 | 50 A | 2.44 hr | 0.26 hr | 386 V | 305 V | 19.3 kW | 15.3 kW |
| | (-2-1-1-1-1-1-1-1-1-) | | | | | | | |

Multiphysics based Kalman filtering, Multiphysics based extended Kalman filtering, and Multiphysics based unscented transform prediction-correction filtering give better estimation of the state variables and model parameters than equivalent circuit model based Kalman filtering, equivalent circuit model based extended Kalman filtering, and equivalent circuit model based unscented transform prediction-correction filtering because multiphysics based models can better capture the dynamics of a battery cell during charge/discharge than equivalent circuit models and other reduced order models. Partial differential equations (PDEs) describing the multiple physical processes for a battery cells are essentially infinite dimension which is not suitable for Kalman filter, extended Kalman filter, and unscented transform prediction-correction filter. These PDEs need to be discretized and transformed into state-space form before they can be used in Kalman filter, extended Kalman filter, and unscented transform prediction-correction filter.

To illustrate this idea, a one-dimensional diffusion equation based simplified battery model is used in a ninth example. The diffusion equation is

$$\frac{\partial c}{\partial t} = D \frac{{\partial }^{2} c}{\partial {x}^{2}}$$

with boundary conditions

$$x = 0 , - D \frac{\partial c}{\partial x} = 0 , x = L , - D \frac{\partial c}{\partial x} = j$$

and initial condition

t=0,c(x)=0.

Assume that diffusional flux is correlated to discharge current density as

$$j = \frac{i}{F}$$

and voltage is looked up based on a concentration dependent open circuit voltage table

$$V = OCV ( \frac{1}{L} {\int }_{0}^{L} cdx ) .$$

This model described above is a simplified battery model considering only diffusion of ions. A real battery would include more physics and kinetics than this one. However, this simplified model is used to illustrate how to convert PDEs to state-space representation.

The diffusion equation can be discretized using second order finite difference for the spatial derivative with implicit Euler for the temporal derivative. The resulting difference equation is

$$A ( h , D , Δ t ) {c}^{n + 1} = b ( {c}^{n} , j , h , D )$$

$$where$$

$$c = {[ {c}_{1} {c}_{2} ⋯ {c}_{N} ]}^{T}$$

$$A ( h , D , Δ t ) = [ \begin{matrix}1 + 2 θ & - 2 θ & & & & \\ - θ & 1 + 2 θ & - θ & & & \\ & ⋯ & ⋯ & ⋯ & & \\ & & ⋯ & ⋯ & ⋯ & \\ & & & - θ & 1 + 2 θ & - θ \\ & & & & - 2 θ & 1 + 2 θ\end{matrix} ]$$

$$θ = \frac{Δ t}{{h}^{2}} D$$

$$b ( {c}^{n} , j , h , D ) = {[ {c}_{1}^{n} {c}_{2}^{n} ⋯ {c}_{N - 1}^{n} {c}_{N}^{n} - 2 θ hj \text{/} D ]}^{T} .$$

The state-space representation is then

$${c}^{n + 1} = {A}^{- 1} ( h , D , Δ t ) b ( {c}^{n} , j , h , D )$$

$${V}^{n + 1} = OCV ( \frac{1}{N} {\sum }_{i = 1}^{N} {c}_{i}^{n + 1} )$$

where input is j or i (j=i/F, where F is Faraday constant), output is V, and state variable is vector c. Once concentration is determined, the state of charge of a battery cell can be simply calculated by averaging the concentration and normalizing by the maximum intercalation concentration.

The resulting state-space representation is nonlinear. Therefore, nonlinearity needs to be treated either by extended Kalman filter or unscented transform based prediction-correction filter. The extended Kalman filter approximates the expectation of a function of a random variable as the function of the expectation of the random variable, and requires calculation of derivatives (Jacobian matrix); this is troublesome when implementing coupled governing equations in multiphysics battery model. The unscented transform based prediction-correction filter approximates the expectation using the statistics of 2N+1 sigma points (N is the dimension of the state variable), requires no calculation of derivatives (Jacobian matrix), and makes the implementation of multiphysics battery model in control feasible. Description on unscented transform based prediction-correction filter is given in U.S. Pat. No. 8,190,384 B2, in the name of Xiangchun Zhang, Yen-Hung Chen, Chia-Wei Wang, and Ann Marie Sastry, and assigned to Sakti3 Inc., which is incorporated by reference herein, where the unscented transform based prediction-correction filter or prediction-correction filter is used with equivalent circuit battery models. The described filter can be used with multiphysics based battery models, as provided by this invention, once the battery model PDEs are converted to state-space representation as described for the one-dimensional diffusion equation.

For the one-dimensional diffusion based simplified battery model described above, if D=1 [m²/s], 0<t<1 [s], V>3.4 [V], j=1 [mol/(m²-s)], and L=1 [m] are used. The unscented transform based prediction-correction filter estimates the state vector c very well. The root mean square error of the estimated first element of c is about 0.28% for 0.5<t<1, and the root mean square error of the estimated last element of c is about 0.18% for 0.5<t<1.

The multiphysics based battery model has multiple PDEs including conduction and diffusion in anode, Butler-Volmer kinetics, conduction and diffusion in electrolyte, diffusion and conduction in cathode. These equations can be similarly converted to state-space representation and implemented with unscented transform based prediction-correction filter.

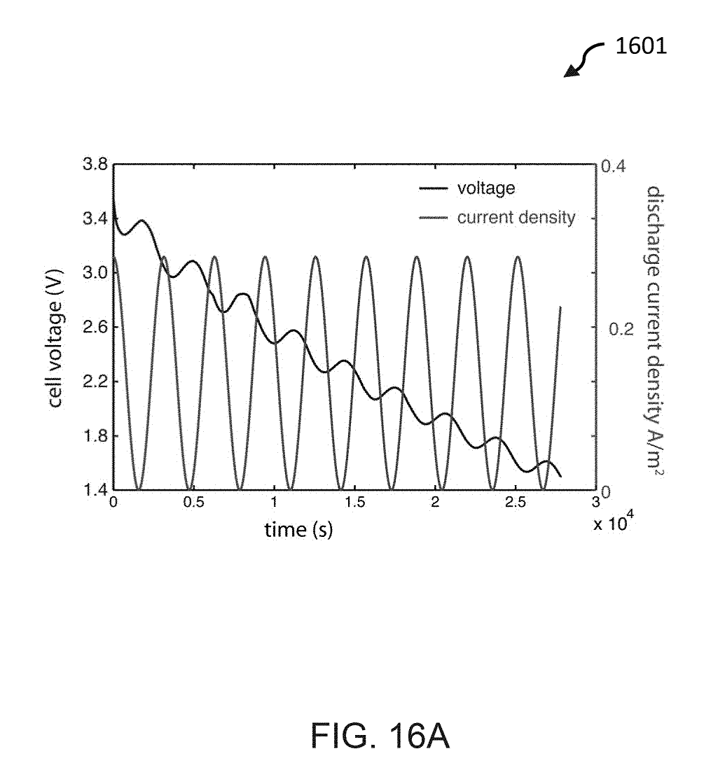

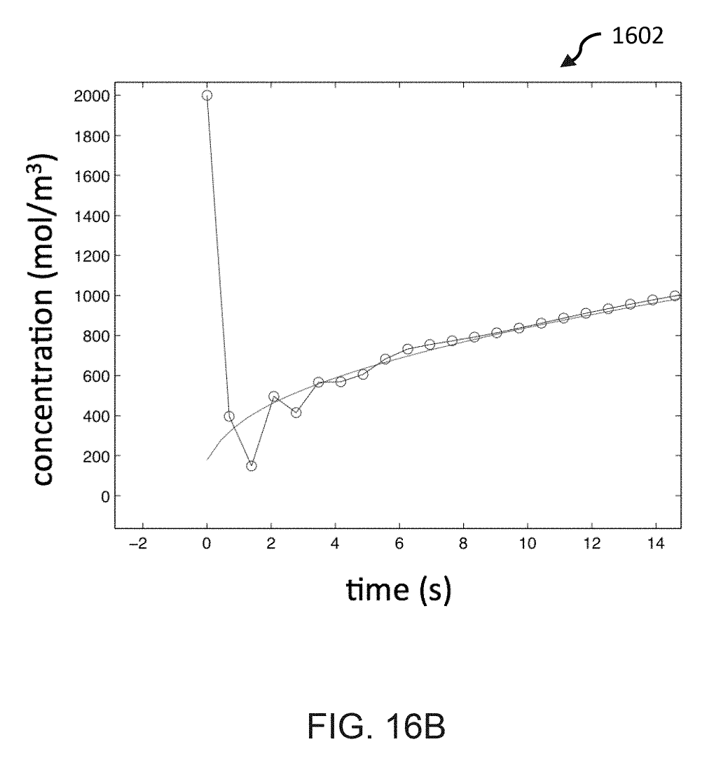

In a tenth example, a multiphysics battery model is used with unscented transform based prediction-correction filter to estimate the concentration of Li ions in cathode, which can be further used to directly calculate the state of charge of the battery cell. FIGS. 16A and 16B are simplified graphs illustrating the voltage response 1601 (FIG. 16A) during a sinusoidal discharge and the convergence of estimated concentration 1602 (FIG. 16B) at cathode and electrolyte interface using multiphysics based unscented transform prediction-correction filter. It is shown by 1602 that the estimated concentration quickly converges to true concentration within about 6 time steps. The estimated concentration in cathode has excellent accuracy with root mean square error less than about 0.002%.

The model parameters for multiphysics based battery model can be determined a priori or can also be estimated jointly with state variable.

In some embodiments, the device can include a battery module comprising a plurality of thinner and thicker cathode battery cells or a battery pack comprising a plurality of battery modules with each module comprising a plurality of thinner and thicker cathode battery cells. In a specific embodiment, the battery pack can include a plurality of battery modules connected in series, in parallel or a combination thereof; wherein the battery module comprises a plurality of battery cells connected in series, in parallel or a combination thereof; wherein the serial and/or parallel connection among the plurality of battery cells are dynamically changed to adjust the voltage of the device during charge and discharge; wherein the serial and/or parallel connection among the plurality of battery modules are dynamically changed to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging.

In an embodiment, each battery cell and/or module being is configured to be associated with six on-off switches to form a repeating group; the switches being transistors; the switches being field effect transistors including metal-oxide-semiconductor field effect transistors; the different series-parallel connection configurations for battery cells and/or modules being achieved by configuring an on and off status of all the on-off switches; the connection configurations being dynamically switched once the battery pack and/or module voltage falls below or rises above a setpoint value.

In an embodiment, the device can include a charger coupled to the device, the charger configured to connect with an energy source to recharge the said device with either a constant current recharge profile, a constant current followed by constant voltage recharge profile, or a constant voltage recharge profile. In a specific embodiment, the thinner cathode electrochemical cell is configured to provide electric energy to heat the thicker cathode electrochemical cell by means of electrical heating when the environmental temperature is below a setpoint value; the temperature setpoint value ranging from −50° C. to 50° C.

It is also understood that the examples and embodiments described herein are for illustrative purposes only and that various modifications or changes in light thereof will be suggested to persons skilled in the art and are to be included within the spirit and purview of this application and scope of the appended claims.

1. An integrated energy storage system comprising:
a first plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, sodium-ion batteries, magnesium-ion batteries, fuel cells, capacitors, and supercapacitors, wherein the first plurality of energy storage units have a gravimetric energy density of greater than 180 Wh/kg and volumetric energy density greater than 450 Wh/L in an environmental temperature above 0° C.;
a second plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, sodium-ion batteries, magnesium-ion batteries, fuel cells, capacitors, and supercapacitors, wherein the second plurality of energy storage units have a gravimetric power density of greater than 450 W/kg and volumetric power density greater than 1080 W/L in an environmental temperature above 0° C.;
a third plurality of energy storage units comprising one or more of lead-acid batteries, nickel-cadmium batteries, nickel-metal hydride batteries, lithium-ion batteries, lithium-ion polymer electrolyte batteries, lithium-ion polymer-gel electrolyte batteries lithium-ion solid-state batteries, lithium-ion solid-state thin-film batteries, metal-air batteries, fuel cells, capacitors, and supercapacitors, wherein the third plurality of energy storage units are configured to operate in an environmental temperature at least as low as −50° C.; and
a controller programmed to receive one or more inputs from one or more voltage sensors, one or more current sensors, and one or more temperature sensors, and to allocate the current or power among the first plurality of energy storage units, the second plurality of energy storage units, and the third plurality of energy storage units depending on a power consumption from an application load and an environmental temperature.

2. The system of claim 1, wherein the controller is programmed to allocate current or power from the second plurality of energy storage units depending on the power consumption from the application load, and the first plurality of energy storage units are configured to handle power to extend operational time.

3. The system of claim 1, wherein the controller is programmed to allocate current or power to the third plurality of energy storage units when the environmental temperature is below a setpoint value, and the controller is configured to allocate current or power to at least the first plurality of energy storage units or the second plurality of energy storage units when the environmental temperature is above their operating temperature lower limit.

4. The system of claim 1, wherein the first plurality of energy storage units have a gravimetric energy density greater than 200 Wh/kg and a volumetric energy density greater than 500 Wh/L in an environmental temperature above 0° C.

5. The system of claim 1, wherein the second plurality of energy storage units have a gravimetric power density greater than 500 W/kg and a volumetric power density greater than 1200 W/L.

6. The system of claim 1, wherein the third plurality of energy storage units are configured to operate in an environmental temperature as low as −100° C.

7. The system of claim 1, wherein the controller is programmed to deliver power from the third plurality of energy storage units to at least the first plurality of energy storage units or second plurality of energy storage units to heat up at least the first plurality of energy storage units or the second plurality of energy storage units.

8. The system of claim 1, wherein the controller is programmed to use a detected voltage value from one or more voltage sensors, a detected current value from one or more current sensors, and a detected temperature from one or more temperature sensors to determine a state-of-charge or remaining capacity of at least one of the first plurality of energy storage units, the second plurality of energy storage units, and the third plurality of energy storage units.

9. The system of claim 8, wherein the controller is programmed to use the determined state-of-charge or remaining capacity of at least one of the first plurality of energy storage units, the second plurality of energy storage units, and the third plurality of energy storage units to balance power deliver from at least one of the first plurality of energy storage units, the second plurality of energy storage units, and the third plurality of energy storage units.

10. The system of claim 1, wherein the controller comprises a charge management system configured to connect with an energy source, such that the charge management system can recharge at least one of the first plurality of energy storage units, the second plurality of energy storage units, and the third plurality of energy storage units.

11. The system of claim 1, wherein the first plurality of energy storage units, the second plurality of energy storage units, and the third plurality of energy storage units are configured to be connected in series or in parallel to adjust the voltage of the system during charge and discharge.

12. An energy storage battery device configured to provide energy for an application load with a pulsed power, the device comprising:
at least two electrochemical cells, each electrochemical cell comprising at least an anode layer, an electrolyte layer, a cathode layer and a current collector layer;
wherein at least one of the electrochemical cells is characterized by a thinner cathode layer configured to supply energy for pulsed power consumption, the thinner cathode layer having a cathode thickness ranging from 0.01 micrometers to 120 micrometers;
wherein at least one of the electrochemical cell is characterized by a thicker cathode layer configured to supply energy for baseline power consumption that is lower than the pulsed power, the thicker cathode layer having a cathode thickness ranging from 0.05 micrometers to 360 micrometers; and
wherein the pulsed power is higher than a baseline power consumed by the application load and lasts less than a minute.

13. The device of claim 12, wherein the thinner cathode layer has a thickness ranging from 0.01 micrometers to 100 micrometers for cathode materials comprising vanadium oxides and their variations including V₂O₅, V_{(2+y)} O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+z)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thinner cathode layer has a thickness ranging from 0.01 micrometers to 110 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thinner cathode layer has a thickness ranging from 0.01 micrometers to 120 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thinner cathode layer has a thickness ranging from 0.01 micrometers to 110 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y})Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thinner cathode layer has a thickness ranging from 0.01 micrometers to 100 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thinner cathode layer has a thickness ranging from 0.01 micrometers to 100 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

14. The device of claim 12, wherein the thicker cathode layer has a thickness ranging from 0.05 micrometers to 300 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thicker cathode layer has a thickness ranging from 0.05 micrometers to 330 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thicker cathode layer has a thickness ranging from 0.05 micrometers to 360 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thicker cathode layer has a thickness ranging from 0.05 micrometers to 330 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thicker cathode layer has a thickness ranging from 0.05 micrometers to 300 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thicker cathode layer has a thickness ranging from 0.05 micrometers to 300 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

15. The device of claim 12, wherein the electrochemical cells are manufactured using an aerosol deposition process or a physical vapor deposition (PVD) processes comprising PVD by thermal techniques, by e-beam heating, by resistance heating, by induction heating, by ion beam heating, by laser ablation, by molecular beam epitaxy, by Ion Beam Assisted Deposition (IBAD), by close coupled sublimation, by gas cluster ion beam; by physical vapor deposition by momentum transfer, by Diode sputtering, by magnetron sputtering, by unbalanced magnetron sputtering, by High power impulse magnetron sputtering, by RF Sputtering, by DC sputtering, by MF sputtering, by Cylindrical Sputtering, by Hollow Cathode Sputtering, by Sputter Evaporation, by Ion beam sputtering, by sputter ion cluster, by Bias Sputtering, by cathodic arc, by filtered cathodic arc; by reactive physical vapor deposition by background gas, by Ion Beam Assisted Deposition (IBAD), by Plasma activated PVD, aerosol deposition and by combinations thereof.

16. The device of claim 12, wherein the electrochemical cells are manufactured using an aerosol deposition process.

17. The device of claim 12, wherein the electrochemical cells having thinner cathode layers can deliver a gravimetric power density greater than 500 W/kg and a volumetric power density greater than 1200 W/L; wherein electrochemical cells having thinner cathode layers can operate in an environmental temperature as low as −100° C.; wherein electrochemical cells having thicker cathode layers can deliver a gravimetric energy density greater than 200 Wh/kg and a volumetric energy density greater than 500 Wh/L; wherein electrochemical cells having thicker cathode layer can deliver a gravimetric energy density greater than 180 Wh/kg and a volumetric energy density greater than 450 Wh/L in an environmental temperature above 0° C.

18. The device of claim 12, further comprising a controller interface configured to detect the power consumption level from a connected application load and allocate the majority or all of a discharge current and/or power to the thinner cathode electrochemical cell for detected high pulsed power and to the thicker cathode electrochemical cell for detected low baseline power; and further comprising a charger coupled to the device, the charger configured to connect with an energy source to recharge the device with either a constant current recharge profile, a constant current followed by constant voltage recharge profile, or a constant voltage recharge profile.

19. The device of claim 12, further comprising a battery module comprising a plurality of thinner and thicker cathode battery cells or a battery pack comprising a plurality of battery modules with each module comprising a plurality of thinner and thicker cathode battery cells.

20. The device of claim 12, further comprising a battery pack comprising a plurality of battery modules connected in series, in parallel or a combination thereof; wherein the battery module comprises a plurality of battery cells connected in series, in parallel or a combination thereof; wherein the serial and/or parallel connection among the plurality of battery cells are dynamically changed to adjust the voltage of the device during charge and discharge; wherein the serial and/or parallel connection among the plurality of battery modules are dynamically changed to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging;
wherein each battery cell and/or module being is configured to be associated with six on-off switches to form a repeating group; the switches being transistors; the switches being field effect transistors including metal-oxide-semiconductor field effect transistors; the different series-parallel connection configurations for battery cells and/or modules being achieved by configuring an on and off status of all the on-off switches; the connection configurations being dynamically switched once the battery pack and/or module voltage falls below or rises above a setpoint value.

21. The device of claim 12, wherein the device is configured to provide energy to an application load from a consumer electronic device, a vehicle, or an electrical grid.

22. The device of claim 12, wherein the at least two electrochemical cells are deposited onto a thin film metal substrate of a thickness of 6 microns or less, preferably of a thickness of 2 microns or less.

23. The device of claim 22, wherein thin film metal substrate is a ribbon of metal foil having a longitudinal length, the device comprising a plurality of solid-state electrochemical cells deposited along the longitudinal length, and wherein the distance between adjacent electrochemical cells deposited on the ribbon substrate increases in a direction of the longitudinal length of the substrate.

24. The device of claim 12, wherein the energy storage battery device is a solid state device, and the at least two electrochemical cells are solid state cells.

25. An energy storage battery device configured to provide energy for an application load during a low temperature start, the device comprising:
at least two electrochemical cells, each electrochemical cell comprising at least an anode layer, an electrolyte layer, a cathode layer, a current collector layer;
wherein at least one of the electrochemical cells is characterized by a thinner cathode layer configured to supply energy in an environmental temperature of −100° C. to a setpoint value ranging from −50° C. to 50° C., the cathode thickness ranging from 0.01 micrometers to 120 micrometers;
wherein at least one of the electrochemical cell is characterized by a thicker cathode layer configured to supply energy in an environmental temperature above a setpoint value ranging from −50° C. to 50° C., the cathode thickness ranging from 0.05 micrometers to 360 micrometers.

26. The device of claim 25, wherein the thinner cathode layer has a thickness ranging from 0.01 micrometers to 100 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thinner cathode layer has a thickness ranging from 0.01 micrometers to 110 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thinner cathode layer has a thickness ranging from 0.01 micrometers to 120 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thinner cathode layer has a thickness ranging from 0.01 micrometers to 110 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z})Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thinner cathode layer has a thickness ranging from 0.01 micrometers to 100 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y})P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thinner cathode layer has a thickness ranging from 0.01 micrometers to 100 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

27. The device of claim 25, wherein the thicker cathode layer has a thickness ranging from 0.05 micrometers to 300 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thicker cathode layer has a thickness ranging from 0.05 micrometers to 330 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thicker cathode layer has a thickness ranging from 0.05 micrometers to 360 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thicker cathode layer has a thickness ranging from 0.05 micrometers to 330 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3++m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thicker cathode layer has a thickness ranging from 0.05 micrometers to 300 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thicker cathode layer has a thickness ranging from 0.05 micrometers to 300 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

28. The device of claim 25, wherein the electrochemical cells are manufactured using physical vapor deposition (PVD) processes comprising PVD by thermal techniques, by e-beam heating, by resistance heating, by induction heating, by ion beam heating, by laser ablation, by molecular beam epitaxy, by Ion Beam Assisted Deposition (IBAD), by close coupled sublimation, by gas cluster ion beam; by physical vapor deposition by momentum transfer, by Diode sputtering, by magnetron sputtering, by unbalanced magnetron sputtering, by High power impulse magnetron sputtering, by RF Sputtering, by DC sputtering, by MF sputtering, by Cylindrical Sputtering, by Hollow Cathode Sputtering, by Sputter Evaporation, by Ion beam sputtering, by sputter ion cluster, by Bias Sputtering, by cathodic arc, by filtered cathodic arc; by reactive physical vapor deposition by background gas, by Ion Beam Assisted Deposition (IBAD), by Plasma activated PVD, and by combinations thereof.

29. The device of claim 25, wherein the electrochemical cells are manufactured using an aerosol deposition process.

30. The device of claim 25, wherein electrochemical cells having thinner cathode layer can deliver gravimetric power density greater than 500 W/kg and volumetric power density greater than 1200 W/L; wherein electrochemical cells having thinner cathode layer can operate in an environmental temperature as low as −50° C.; wherein electrochemical cells having thicker cathode layer can deliver gravimetric energy density greater than 200 Wh/kg and volumetric energy density greater than 500 Wh/L; wherein electrochemical cells having thicker cathode layer can deliver gravimetric energy density greater than 180 Wh/kg and volumetric energy density greater than 450 Wh/L in an environmental temperature above 0° C.

31. The device of claim 25, further comprising a controller interface configured to provide energy to the application load by detecting the environmental temperature and allocating the majority or all of a discharge current and/or power to the thinner cathode electrochemical cell for detected lower environmental temperature no more than a setpoint value and to the thicker cathode electrochemical cell for detected higher environmental temperature above a setpoint value; the temperature setpoint value ranging from −50° C. to 50° C.

32. The device of claim 25, wherein the controller comprises a charge management system configured to connect with an energy source, such that the charge management system can recharge the device with either a constant current recharge profile, a constant current followed by constant voltage recharge profile, or a constant voltage recharge profile.

33. The device of claim 25, wherein the thinner cathode electrochemical cell is configured to provide electric energy to heat the thicker cathode electrochemical cell by electrical heating when the environmental temperature is below a setpoint value; the temperature setpoint value ranging from −50° C. to 50° C.

34. The device of claim 25, further comprising a battery module comprising a plurality of thinner and thicker cathode battery cells or a battery pack comprising a plurality of battery modules with each module comprising a plurality of thinner and thicker cathode battery cells.

35. The device of claim 25, further comprising a battery pack comprising a plurality of battery modules connected in series, in parallel or a combination thereof; wherein the battery module comprising a plurality of battery cells connected in series, in parallel or a combination thereof; wherein the serial and/or parallel connection among the battery cells are dynamically changed to adjust the voltage of the device during charge and discharge;
wherein the serial and/or parallel connection among battery modules are dynamically changed to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging;
wherein the different series-parallel connection configurations for battery cells and/or modules are achieved by configuring the on and off status of all the on-off switches; each battery cell and/or module being configured to be associated with six on-off switches to form a repeating group; the switches being transistors; the switches being field effect transistors including metal-oxide-semiconductor field effect transistors; the connection configurations being dynamically switched once the battery pack and/or module voltage falls below or rises above a setpoint value.

36. The device of claim 35, wherein the device is configured to provide energy to an application load from a consumer electronic device, a vehicle, or an electrical grid.

37. The device of claim 25, wherein the energy storage battery device is a solid state device, and the at least two electrochemical cells are solid state cells.

38. A system to control an energy storage battery device having thinner cathode electrochemical cells and thicker cathode electrochemical cells designed for pulsed power loads and low temperature starts, the system comprising:
a voltage sensor configured to monitor a voltage of the battery device;
a current sensor configured to monitor a current through the battery device;
a battery temperature sensor configured to monitor a temperature of the battery;
an environmental temperature sensor configured to monitor the environmental temperature; and
at least a controller configured to receive one or more inputs from the voltage sensor, the current sensor, and the temperature sensors, and to transmit a control signal to allocate the majority or all of a discharge current and/or power between the thinner cathode electrochemical cells and the thicker cathode electrochemical cells depending on a power consumption from the power load and the environmental temperature.

39. The system of claim 38, wherein the controller is configured to allocate the majority or all of a discharge current and/or power between the thinner and thicker cathode electrochemical cells;
the majority or all of the discharge current and/or power being allocated to:
thinner cathode electrochemical cell when the power consumption is higher during pulse power and/or when the environmental temperature is at a setpoint value ranging from −50° C. to 50° C.; and
thicker cathode electrochemical cell when the power consumption is lower during baseline power and/or when the environmental temperature is above the setpoint value.

40. The system of claim 39, wherein the controller is configured to partition an energy/power delivered from the thinner cathode electrochemical cells and to use part of the energy/power to heat up the thicker cathode electrochemical cells when the environmental temperature is below the setpoint value.

41. The system of claim 38, wherein the controller is configured to dynamically change the serial and/or parallel connections among the electrochemical cells and/or modules in the solid-state energy storage battery device to adjust the voltage of the device during charge and discharge; wherein the serial and/or parallel connections among cells and/or modules are dynamically switched among different series-parallel connection configurations to achieve a desirable battery pack and/or module voltage range, to achieve balancing among the modules and/or cells, to bypass a malfunctioning module and/or cell, and to prepare the modules and/or cells for recharging;
wherein the different series-parallel connection configurations for battery cells and/or modules are achieved by configuring the on and off status of all the on-off switches; each battery cell and/or module being configured to be associated with six on-off switches to form a repeating group; the switches being transistors; the switches being field effect transistors including metal-oxide-semiconductor field effect transistors; the connection configurations being dynamically switched once the battery pack and/or module voltage falls below or rises above the setpoint value.

42. The system of claim 38, wherein the controller is configured to use a detected voltage value from the voltage sensor, a detected current value from the current sensor, and a detected temperature from the temperature sensor to determine a state-of-charge and remaining capacity of the thinner and thicker cathode electrochemical cells; wherein the controller is configured to determine the state of charge of the electrochemical cells using voltage look-up, coulomb counting, Kalman filtering, extended Kalman filtering, unscented transform based prediction-correction filtering; wherein the controller is configured to determine the state of charge of the electrochemical cells using physics-based battery models, equivalent circuit battery models, and other reduced-order battery models along with Kalman filtering, extended Kalman filtering, unscented transform based prediction-correction filtering; wherein the controller is configured to use the determined state-of-charge and remaining capacity of the thinner and thicker electrochemical cells to balance these cells based on a power load profile and the environmental temperature.

43. The system of claim 38, wherein the controller comprises a charge management system configured to connect with an energy source, such that the charge management system can recharge the energy storage battery device with a constant current recharge profile, a constant current followed by constant voltage recharge profile, or a constant voltage recharge profile; wherein the controller is configured to provide a specified amount of charge current to the thinner cathode and thicker cathode electrochemical cells based on a nominal capacity and the state-of-charge of each of these respective cells.

44. The system of claim 38, wherein the thinner cathode layer has a thickness ranging from 0.01 micrometers to 100 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thinner cathode layer has a thickness ranging from 0.01 micrometers to 110 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thinner cathode layer has a thickness ranging from 0.01 micrometers to 120 micrometers for cathode materials comprising cobalt oxides and their variations including CoO₂, LiCoO₂, LiₓCO_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thinner cathode layer has a thickness ranging from 0.01 micrometers to 110 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thinner cathode layer has a thickness ranging from 0.01 micrometers to 100 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thinner cathode layer has a thickness ranging from 0.01 micrometers to 100 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

45. The system of claim 38, wherein a thickness of the thicker cathode layer has a thickness ranging from 0.05 micrometers to 300 micrometers for cathode materials comprising vanadium oxides and their variations including V₂O₅, V_{(2+y)}O_{(5+z)} (−0.5<y<0.5, −0.5<z<0.5), V₃O₈, LiₓV₂O₅ (0≤x<3), LiₓV_{(2+y)}O_{(5+z)} (0≤x<3, −0.5<y<0.5, −0.5<z<0.5), LiₓV₃O₈ (0≤x<4), V₆O₁₃, V₅O₁₅, VO₂, V₂O₄, and LiₓV_{(2+y)}O_{(5+z)} (0≤x<3, −0.5<y<0.5, −0.5<z<0.5) doped with Ag, Cu, Fe, Zn, RuO₂ and a combination of thereof, in amorphous, crystalline or semi-crystalline form; wherein the thicker cathode layer has a thickness ranging from 0.05 micrometers to 330 micrometers for cathode materials comprising manganese oxides and their variations including Mn₂O₄, LiₓMn₂O₄ (0≤x<2), LiₓMn_{2+y}O_{4+z} (0≤x<2, −0.5<y<0.5, −0.5<z<0.5), Mn₂O₃, LixMn₂O₃ (0≤x<2), and LiₓMn_{2+y}O_{4+z} (0≤x<2, −0.5<y<0.5, −0.5<z<0.5) doped with Al, Co, Cr, Cu, Fe, Mg, Ni, Pt, and a combination of thereof, in amorphous, crystalline or semi-crystalline form; wherein the thicker cathode layer has a thickness ranging from 0.05 micrometers to 360 micrometers for cathode materials comprising cobalt oxides and their variations including CoO₂, LiCoO₂, LiₓCo_{(1+y)}O_{(2+z)} (0≤x<1.1, −0.5<y<0.5, −0.5<z<0.5), and LiₓCo_{(1+y)}O_{(2+z)} (0≤x<1.1, −0.5<y<0.5, −0.5<z<0.5) doped with Al, Cr, Cu, Fe, Mg, Ni, Mn, Pt, Zn, and a combination thereof, in amorphous, crystalline or semi-crystalline form; wherein the thicker cathode layer has a thickness ranging from 0.05 micrometers to 330 micrometers for cathode materials comprising lithium manganese cobalt oxides and their variations including Ni_{1/3}Co_{1/3}Mn_{1/3}O₂, LiNi_{1/3}Co_{1/3}Mn_{1/3}O₂, LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), LiₓNi_{(1/3+y)}Co_{(1/3+z)}Mn_{(1/3+m)}O₍₂₊ₙ₎ (0≤x<1.1, −1/3≤y≤2/3, −1/3≤z≤2/3, −1/3≤m≤2/3, −0.5<n<0.5), and LiₓNi_{y}Co_{z} (0≤x<1.1, 1/3≤y≤2/3, −1/3≤z≤2/3) doped with Al, F, Fe, Mg, Si, and a combination thereof, in amorphous, crystalline or semi-crystalline form; wherein the thicker cathode layer has a thickness ranging from 0.05 micrometers to 300 micrometers for cathode materials comprising iron phosphates and their variations including FePO₄, LiFePO₄, MPO₄ (M=V, Mn, Co, Ni, or Fe), LiMPO₄ (M=V, Mn, Co, Ni, or Fe), LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5), and LiₓM_{(1+y)}P_{(1+z)}O₍₄₊ₘ₎ (M=V, Mn, Co, Ni, or Fe, 0≤x<1.1, −0.5<y<0.5, −0.5<z<0.5, −0.5<m<0.5) doped with Ag, C, Cu, Fe, Mg, Mn, Ti, Zn, and a combination thereof, in amorphous, crystalline or semi-crystalline form; wherein the thicker cathode layer has a thickness ranging from 0.05 micrometers to 300 micrometers for cathode materials comprising sulfur, lithium sulfide and their variations including S₈, Li₂S, Li₂S₄, LiₓS_{y} (0≤x<16, 1≤y≤8) and LiₓS_{y} (0≤x<16, 1≤y≤8) doped with carbon, in amorphous, crystalline or semi-crystalline form.

46. The system of claim 38, wherein the electrochemical cells are manufactured using physical vapor deposition (PVD) processes comprising PVD by thermal techniques, by e-beam heating, by resistance heating, by induction heating, by ion beam heating, by laser ablation, by molecular beam epitaxy, by Ion Beam Assisted Deposition (IBAD), by close coupled sublimation, by gas cluster ion beam; by physical vapor deposition by momentum transfer, by Diode sputtering, by magnetron sputtering, by unbalanced magnetron sputtering, by High power impulse magnetron sputtering, by RF Sputtering, by DC sputtering, by MF sputtering, by Cylindrical Sputtering, by Hollow Cathode Sputtering, by Sputter Evaporation, by Ion beam sputtering, by sputter ion cluster, by Bias Sputtering, by cathodic arc, by filtered cathodic arc; by reactive physical vapor deposition by background gas, by Ion Beam Assisted Deposition (IBAD), by Plasma activated PVD, and by combinations thereof.

47. The device of claim 38, wherein the electrochemical cells are manufactured using an aerosol deposition process.

48. The system of claim 38, wherein electrochemical cells having thinner cathode layer can deliver gravimetric power density greater than 500 W/kg and volumetric power density greater than 1200 W/L; wherein electrochemical cells having thinner cathode layer can operate in an environmental temperature as low as −100° C.; wherein electrochemical cells having thicker cathode layer can deliver gravimetric energy density greater than 200 Wh/kg and volumetric energy density greater than 500 Wh/L; wherein electrochemical cells having thicker cathode layer can deliver gravimetric energy density greater than 180 Wh/kg and volumetric energy density greater than 450 Wh/L in an environmental temperature above 0° C.

49. The device of claim 38, wherein the energy storage battery device is a solid state device, and the at least two electrochemical cells are solid state cells.
